(19) United States
(12) Patent Application Publication
(10) Pub. No.: US 2026/0198613 A1
(43) Pub. Date: Jul. 16, 2026

(54) HEATING ASSEMBLY, CLEANING ASSEMBLY, AND AEROSOL GENERATING DEVICE

(71) Applicant: SMOORE INTERNATIONAL HOLDINGS LIMITED, Grand Cayman (KY)

(72) Inventors: Lewen CHEN, Shenzhen (CN); Yubin Xian, Shenzhen (CN); Xuewen Liang, Shenzhen (CN); Rihong Li, Shenzhen (CN); Hongming Zhou, Shenzhen (CN)

(73) Assignee: SMOORE INTERNATIONAL HOLDINGS LIMITED, Grand Cayman (KY)

(21) Appl. No.: 19/558,822

(22) Filed: Mar. 6, 2026

Related U.S. Application Data
(63) Continuation of application No. PCT/CN2024/111529, filed on Aug. 12, 2024.

(30) Foreign Application Priority Data
Sep. 8, 2023 (CN) 202311162649.9
Sep. 8, 2023 (CN) 202311163631.0

(51) Int. Cl. A24F 40/85; A24F 40/46; H05B 3/46

(52) U.S. Cl. CPC A24F 40/85; A24F 40/46; H05B 3/46

(57) ABSTRACT

A heating assembly, a cleaning assembly, and an aerosol generating device are provided. The aerosol generating device includes the heating assembly and the cleaning assembly. The heating assembly includes an outer tube and a heat generation mechanism disposed in the outer tube. The cleaning assembly includes a hollow member and an electrode, where the hollow member is detachably sleeved outside the outer tube, the electrode is disposed between the hollow member and the outer tube and forms a gap with an outer wall of the outer tube, and the electrode is configured to generate plasma in a gap.

### RELATED APPLICATIONS

This application is a continuation application of International application No. PCT/CN2024/111529, filed on August 12, 2024, which claims priorities to Chinese Patent Application No. 202311162649.9, filed on September 8, 2023 and Chinese Patent Application No. 202311163631.0, filed on September 8, 2023. The entire disclosure of the prior applications is hereby incorporated by reference.

### TECHNICAL FIELD

This application relates to the field of aerosol generating devices, including to a heating assembly, a cleaning assembly, and an aerosol generating device.

### BACKGROUND

In the related art, an aerosol generating device can heat an aerosol generating substrate to form an aerosol. The aerosol generating device includes an outer tube. The outer tube may be in contact with the aerosol generating substrate. Residues easily attach to the outer tube after the aerosol generating substrate forms the aerosol. The residuals tend to reduce the efficiency of heating the aerosol generating substrate, and is disadvantageous to generation of the aerosol.

### SUMMARY

This disclosure provides a heating assembly, a cleaning assembly, and an aerosol generating device.

The heating assembly in an aspect of this disclosure includes an outer tube, a first electrode, a second electrode, and an insulating partition member. The outer tube is configured for contact with an aerosol generating substrate. The first electrode and the second electrode are both at least partially disposed in the outer tube, and the first electrode and the second electrode are spaced apart. The insulating partition member is disposed between the first electrode and the second electrode, where a gap is formed between the first electrode and/or the second electrode and the insulating partition member, and plasma is generated in the gap when the first electrode and the second electrode are energized.

According to the heating assembly in this aspect of this disclosure, the plasma is generated in the gap between the first electrode and/or the second electrode and the insulating partition member, and the aerosol generating substrate is heated by using a plasma generation process and a high temperature of the plasma, thereby shortening a preheat time and a heat time required for forming an aerosol.

In an aspect, the insulating partition member is a tube, the first electrode is at least partially inserted into the insulating partition member, and the second electrode is located outside the insulating partition member.

In an aspect, the insulating partition member includes a closed end and an open end opposite to the closed end, the closed end is located in the outer tube, and the first electrode is inserted into the insulating partition member from the open end.

In an aspect, the second electrode is a tube, the second electrode is sleeved outside the insulating partition member, and the upper end surface of at least one of the first electrode and the second electrode is lower than the upper end surface of the insulating partition member.

In an aspect, a hollowed-out portion is formed on the second electrode, and the hollowed-out portion enables the insulating partition member to partially face the outer tube through the hollowed-out portion.

In an aspect, the wall thickness of the insulating partition member ranges from 0.2 mm to 1 mm.

In an aspect, the second electrode is adhered to the insulating partition member, or the second electrode is adhered to the inner wall of the outer tube.

In an aspect, the heating assembly includes an infrared radiation film, and the infrared radiation film is disposed on at least one of the insulating partition member, the outer tube, the first electrode, and the second electrode.

In an aspect, the insulating partition member includes a first insulating partition member and a second insulating partition member, the first insulating partition member wraps the first electrode, the second insulating partition member wraps the second electrode, and the first electrode and the second electrode are disposed in parallel.

In an aspect, the heating assembly includes a sealing member, the sealing member is sealedly connected to the inner wall of the outer tube and forms a first enclosed space with the outer tube, the first enclosed space is filled with a working gas, and the first electrode and/or the second electrode is at least partially located in the first enclosed space.

In an aspect, the heating assembly includes a base, a second enclosed space is formed in the base, and the part of the first electrode located outside the first enclosed space and/or the end of the outer tube having an opening is located in the second enclosed space.

The cleaning assembly in an aspect of this disclosure includes a hollow member and an electrode. The hollow member is configured to be detachably sleeved outside an outer tube of an aerosol generating device. The electrode is disposed in the hollow member and configured to form a gap with the outer wall of the outer tube, and the electrode is configured to generate plasma in the gap.

The aerosol generating device in an aspect of this disclosure includes a heating assembly and a cleaning assembly. The heating assembly includes an outer tube and a heat generation mechanism disposed in the outer tube. The cleaning assembly includes a hollow member and an electrode, where the hollow member is detachably sleeved outside the outer tube, the electrode is disposed between the hollow member and the outer tube and forms a gap with the outer wall of the outer tube, and the electrode is configured to generate plasma in the gap.

According to the aerosol generating device in an aspect of this disclosure, the plasma generated between the hollow member and the outer tube by the electrode heats and cleans aerosol residues attaching to the outer tube, thereby improving the efficiency of heating the aerosol generating substrate by the heating assembly.

In an aspect, the heat generation mechanism includes a first electrode and a second electrode, the first electrode and the second electrode are both at least partially disposed in the outer tube, the first electrode and the second electrode are opposite disposed and are spaced apart, and plasma is generated between the first electrode and the second electrode when the first electrode and the second electrode are energized.

In an aspect, the cleaning assembly includes a third electrode and a fourth electrode, the electrode is the third electrode, the third electrode is disposed between the hollow member and the outer tube, the fourth electrode is at least partially disposed in the outer tube, and the plasma is generated in the gap when the third electrode and the fourth electrode are energized.

In an aspect, the fourth electrode and the second electrode are configured as the same electrode. In an aspect, when the first electrode and the second electrode are energized, the third electrode and the fourth electrode are de-energized; and when the third electrode and the fourth electrode are energized, the first electrode and the second electrode are de-energized.

In an aspect, the aerosol generating device includes a power source, the second electrode is electrically connected to a first power supply terminal of the power source, when the hollow member is sleeved outside the outer tube, the third electrode is electrically connected to a second power supply terminal of the power source, and when the hollow member is separated from the outer tube, the first electrode is electrically connected to the second power supply terminal of the power source.

In an aspect, the aerosol generating device includes a power connection assembly, the power connection assembly includes a first connector, a second connector, and a third connector, the first connector is connected to the first electrode, the second connector is electrically connected to the second power supply terminal, and the third connector is disposed on the hollow member and is electrically connected to the third electrode; and

when the hollow member is sleeved outside the outer tube, the second connector is in contact with the third connector, and when the hollow member is separated from the outer tube, the second connector is in contact with the first connector.

In an aspect, the power connection assembly includes an insulating member and an elastic member, the insulating member is connected to the third connector, the elastic member is connected to the first connector, in a process of sleeving the hollow member on the outer tube, the insulating member pushes the first connector to move relative to the second connector, to separate the first connector from the second connector and deform the elastic member, and in a process of separating the hollow member from the outer tube, the elastic member recovers from deformation, to push the first connector to come into contact with the second connector.

In an aspect, the third electrode is a tube and is disposed on the inner wall of the hollow member.

In an aspect, the heating assembly includes an inner tube, the inner tube is at least partially disposed in the outer tube, the first electrode is at least partially disposed in the inner tube, and the second electrode is at least partially disposed at one end of the inner tube.

In an aspect, the inner tube includes a first end surface and a second end surface opposite to the first end surface, the first electrode exposes the inner tube on the first end surface, and the second electrode abuts against the second end surface.

In an aspect, the electrode is a third electrode, and when the first electrode and the second electrode are energized, the third electrode and the second electrode are de-energized; and when the third electrode and the second electrode are energized, the first electrode and the second electrode are de-energized.

Additional aspects and advantages of this disclosure are provided in the following descriptions, and some become apparent from the following descriptions or may be learned from practices of this disclosure.

### BRIEF DESCRIPTION OF THE DRAWINGS

The foregoing and/or additional aspects and advantages of this disclosure become apparent and easily understood from the descriptions of embodiments with reference to the following accompanying drawings.

FIG. 1 is a schematic partial structural diagram of an aerosol generating device according to an aspect of this disclosure;

FIG. 2 is a schematic cross-sectional structural view of a heating assembly in an aspect of FIG. 1;

FIG. 3 is a schematic structural diagram of an aerosol generating device according to an aspect of this disclosure;

FIG. 4 is a schematic three-dimensional structural view of a heating assembly according to an aspect of this disclosure;

FIG. 5 is a schematic exploded structural view of the heating assembly in FIG. 4;

FIG. 6 is a schematic partial enlarged view of a part A in FIG. 2;

FIG. 7 is a schematic partial structural diagram of a heating assembly according to an aspect of this disclosure;

FIG. 8 is a schematic cross-sectional structural view of a heating assembly according to an aspect of this disclosure;

FIG. 9 is a schematic partial structural diagram of a heating assembly according to still an aspect of this disclosure;

FIG. 10 is a bottom view of a schematic structural diagram of a heating assembly according to an aspect of this disclosure;

FIG. 11 is a bottom view of a schematic structural diagram of a heating assembly according to an aspect of this disclosure;

FIG. 12 is a bottom view of a schematic structural diagram of a heating assembly according to an aspect of this disclosure;

FIG. 13 is a bottom view of a schematic structural diagram of a heating assembly according to yet an aspect of this disclosure;

FIG. 14 is a schematic three-dimensional structural view of a heating assembly according to an aspect of this disclosure;

FIG. 15 is a schematic cross-sectional view of the heating assembly in FIG. 14 in a direction B-B;

FIG. 16 is a schematic diagram of combination of a heating assembly and a cleaning assembly according to an aspect of this disclosure;

FIG. 17 is a schematic structural diagram of an aerosol generating device according to an aspect of this disclosure;

FIG. 18 is a schematic structural diagram of a heating assembly in FIG. 17;

FIG. 19 is a schematic structural diagram of a power connection assembly according to an aspect of this disclosure; and

FIG. 20 is a schematic structural diagram of a power connection assembly according to an aspect of this disclosure in another case.

### Reference numerals:

aerosol generating device 1000, aerosol generating substrate 300, control center 400, PCBA board 410, control circuit 420, and cover body 500;

heating assembly 100, heat generation mechanism 1100, inner tube 10a, first end surface 11, second end surface 12, insulating partition member 10b, closed end 13, open end 14, first insulating partition member 151, second insulating partition member 152, outer tube 20, outer wall 2001, tapered end portion 21, exposed end 22, sealing member 23, first enclosed space 201, first electrode 110, second electrode 120, protrusion 122, discharge region 130, thermal insulation gap 1002, gap 1300, first gap 1101, second gap 1202, base 90, center hole 1201, gap 1300, solenoid 30a, power connection wire 33, hollowed-out portion 35, infrared radiation film 60, first gap 1101, second gap 1202, first interval 2010, second interval 2020, base 90, and second enclosed space 902;

power source 200, first power supply terminal 211, second power supply terminal 212, battery

210, transformer 220, first secondary side 221, and second secondary side 222; and

cleaning assembly 600, hollow member 610, side enclosure 611, hollow interval 612, electrode 620, third electrode 630, fourth electrode 640, cleaning gap 603, power connection assembly 650, first connector 651, second connector 652, third connector 653, insulating member 654, elastic member 655, and spring 6551.

### DETAILED DESCRIPTION

Aspects of this disclosure are described in detail below, and examples of the aspects are shown in the accompanying drawings, where the same or similar elements having same or similar functions are denoted by the same or similar reference numerals throughout the descriptions. The following aspects described with reference to the accompanying drawings are exemplary, and are merely used for explaining this disclosure, but cannot be understood as a limitation on this disclosure.

In the descriptions of this disclosure, it should be understood that orientation or position relationships indicated by terms such as "center", "longitudinal", "transverse", "length", "width", "thickness", "up", "down", "front", "rear", "left", "right", "vertical", "horizontal", "top", "bottom", "inside", "outside", "clockwise", and "counterclockwise" are based on orientation or position relationships shown in the accompanying drawings, and are merely used for ease and brevity of description of this disclosure, rather than indicating or implying that the mentioned device or element needs to have a particular orientation or be constructed and operated in a particular orientation. Therefore, such terms should not be construed as a limitation on this disclosure. In addition, the terms "first" and "second" are used merely for descriptive purposes and are not to be construed as indicating or implying relative importance or to implicitly indicate the number of technical features indicated. Therefore, a feature defined by "first" and "second" may explicitly or implicitly include one or more of the features. In the descriptions of this disclosure, "a plurality of" means two or more, unless otherwise definitely and specifically limited.

In the descriptions of this disclosure, it should be noted that unless otherwise explicitly specified and defined, terms "mounted", "connected", and "connection" should be understood in broad sense, for example, fixed connection, detachable connection, or integral connection; or may be a mechanical connection, an electrical connection, or mutual communication; or may be a direct connection, an indirect connection through an intermediate medium, internal communication between two elements, or an interaction relationship between two elements. A person of ordinary skill in the art may understand specific meanings of the foregoing terms in this disclosure according to specific situations.

In this disclosure, unless otherwise explicitly specified and defined, a first feature being "on" or "under" a second feature may include that the first feature and the second feature are in direct contact, or the first feature and the second feature are not in direct contact but in contact by using another feature therebetween. In addition, the first feature being "above", "over", or "on" the second feature may mean that the first feature is directly and obliquely above the second feature, or merely indicate that the first feature is at a higher horizontal level than the second feature. The first feature being "below", "under", and "beneath" the second feature may mean that the first feature is directly and obliquely below the second feature, or merely indicate that the first feature is at a lower horizontal level than the second feature. The following disclosure provides many different aspects or examples for implementing different structures of this disclosure. To simplify the disclosure of this disclosure, components and settings of particular examples are described below. Certainly, the descriptions are merely examples, and are not intended to limit this disclosure. In addition, in this disclosure, reference numerals and/or reference letters may be repeated in different examples. This repetition is for simplicity and clarity, and does not indicate a relationship between various aspect and/or arrangements discussed. In addition, this disclosure provides examples of various specific processes and materials, but a person of ordinary skill in the art may be aware of disclosure of other processes and/or use of other materials.

### Example 1:

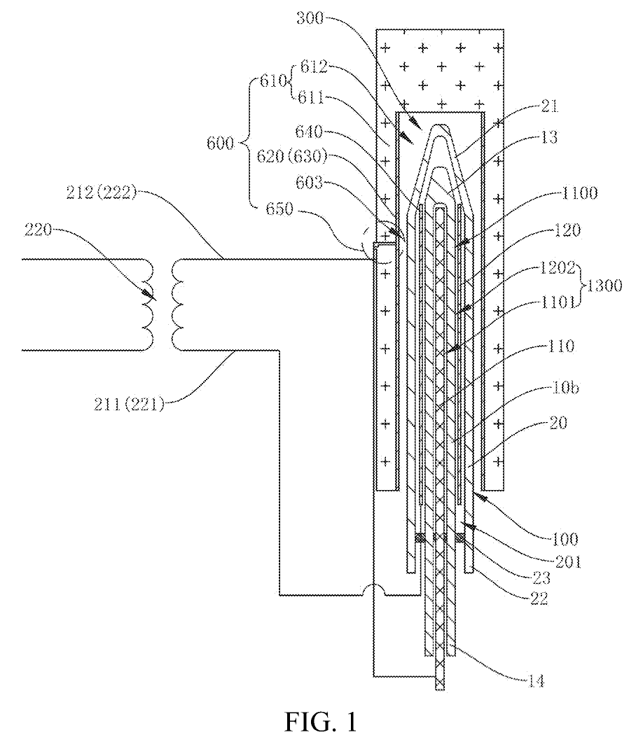

Referring to FIG. 1 to FIG. 3, a heating assembly 100 according to an example of this disclosure includes an insulating partition member 10b, an outer tube 20, a first electrode 110, and a second electrode 120. The outer tube 20 is configured for contact with an aerosol generating substrate 300. The first electrode 110 and the second electrode 120 are both at least partially disposed in the outer tube 20, and the first electrode 110 and the second electrode 120 are spaced apart.

The insulating partition member 10b is disposed between the first electrode 110 and the second electrode 120, and a gap 1300 is formed between the first electrode 110 and/or the second electrode 120 and at least a part of the insulating partition member 10b. When the first electrode 110 and the second electrode 120 are energized, plasma is controlled to be generated in the gap 1300.

According to the heating assembly 100 in this example of this disclosure, the plasma is generated in the gap 1300 between the first electrode 110 and/or the second electrode 120 and the insulating partition member 10b, and the aerosol generating substrate 300 is heated by using a plasma generation process and a high temperature of the plasma, thereby shortening a preheat time and a heat time required for forming an aerosol.

The first electrode 110 and the second electrode 120 generate the plasma through a dielectric barrier discharge. The dielectric barrier discharge (DBD) is a high-voltage electric discharge between two electrodes separated by an insulating dielectric barrier layer. The insulating dielectric is a material having very low electric conductivity. The structure of a DBD apparatus is similar to the structure of a capacitor because the insulating dielectric exists between the two electrodes. The DBD apparatus can conduct an alternating current but hardly conduct a direct current. The dielectric barrier discharge is uniform and stable, and a discharging process is close to mute.

A high-voltage alternating current is applied to the first electrode 110 and the second electrode 120. When electrons between the first electrode 110 and the second electrode 120 are accelerated by a strong electric field and gain enough energy to overcome an energy barrier in the dielectric, resulting in electron penetration, the plasma is formed.

The first electrode 110 and the second electrode 120 are separated by using the insulating partition member 10b. The plasma is generated both between the first electrode 110 and the insulating partition member 10b and between the second electrode 120 and the insulating partition member 10b.

In an aspect, a first gap 1101 is formed between the first electrode 110 and the insulating partition member 10b, and a second gap 1202 is formed between the second electrode 120 and the insulating partition member 10b. The gap 1300 includes the first gap 1101 and the second gap 1202.

In an aspect, a first gap 1101 is formed between the first electrode 110 and the insulating partition member 10b. The second electrode 120 may be in close contact with the insulating partition member 10b, and cover the partial surface of the insulating partition member 10b facing the outer tube 20. The gap 1300 is the first gap 1101.

In an aspect, the first electrode 110 may be in close contact with the insulating partition member 10b, and cover at least a part of the insulating partition member 10b. A second gap 1202 is formed between the second electrode 120 and the insulating partition member 10b, and the gap 1300 is the second gap 1202.

The width of the first gap 1101 or the second gap 1202 may range from 0.1 mm to 1.0 mm (where the range includes endpoint values, and similar expression manners for the following value ranges can be equivalently understood).

It needs to be noted that the plasma is a material form that includes a large quantity of charged particles, and neutral atoms and molecules, and keeps charge neutral as a whole. Under an effect of an electric field, a gas may be ionized to generate the plasma. A large amount of heat can be generated in a process of plasma generation, and the temperature of the plasma in a working state may reach 1400 °C to 2000 °C.

According to the heating assembly 100 in this example of this disclosure, the aerosol generating substrate 300 is heated by using the high temperature in the process of plasma generation and the high temperature of the plasma. The heat of the plasma generation between the first electrode 110 and the insulating partition member 10b and between the second electrode 120 and the insulating partition member 10b is transmitted or radiated to the aerosol generating substrate 300 through the outer tube 20, so that the aerosol generating substrate 300 absorbs the heat, to form an aerosol.

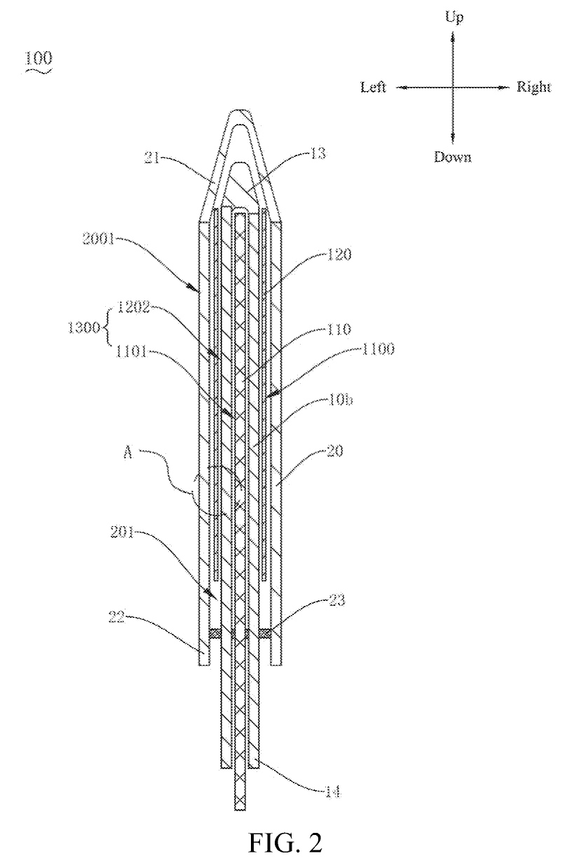

Referring to FIG. 2, in an aspect, the first electrode 110 is opposite to the second electrode 120, and the first gap 1101, the insulating partition member 10b, and the second gap 1202 are sequentially provided between the first electrode 110 and the second electrode 120. An alternating current may be applied to the first electrode 110 and the second electrode 120, and the plasma is formed in the first gap 1101 and the second gap 1202. The heat of the plasma may be transferred to the aerosol generating substrate 300 by heat conduction or infrared radiation through the second electrode 120, the insulating partition member 10b, and the outer tube 20. In an aspect, a working gas may be charged between the first electrode 110 and the second electrode 120. The working gas mainly exists in the first gap 1101 and the second gap 1202. The working gas may be air, nitrogen, argon, carbon dioxide, or the like.

The first electrode 110 may be made of metal and/or alloy that has good electrical conduction. The first electrode 110 may be made of different materials based on different working gases. For example, the first electrode 110 may be made of at least one of materials such as coppery alloy, nickel and nickel-based alloy, stainless steel, zirconium, hafnium, and tungsten.

For example, a material of the first electrode 110 is tungsten. Tungsten has a high melting point and is resistant to a high temperature. An arc is easily generated by using the first electrode 110 made of tungsten.

However, the oxidation resistance of tungsten is relatively poor. The first electrode 110 made of tungsten needs to be filled with a working gas that does not tend to oxidation, such as nitrogen, argon, and carbon dioxide, but a working gas containing oxygen, such as air, cannot be used.

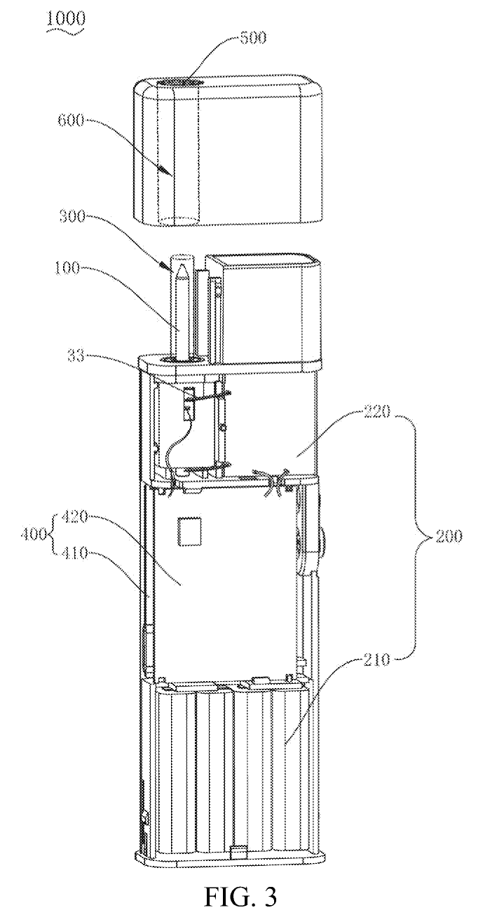

For example, referring to FIG. 1 and FIG. 3, the first electrode 110 and the second electrode 120 are configured to be subjected to an alternating current. The first electrode 110 and the second electrode 120 may be respectively connected to two poles of a power source 200. The power source 200 may include a battery 210, a control circuit 420, and a transformer 220. The transformer 220 may be configured to inverting boost. A direct current of the battery 210 generates a high-voltage alternating current after passing through the control circuit 420 and the transformer 220. The frequency of the alternating current may be 10 kHz to 1 MHz.

The alternating current has the frequency of 10 kHz to 1 MHz, and may reach voltage and power parameters required by the dielectric barrier discharge, thereby heating the aerosol generating substrate 300.

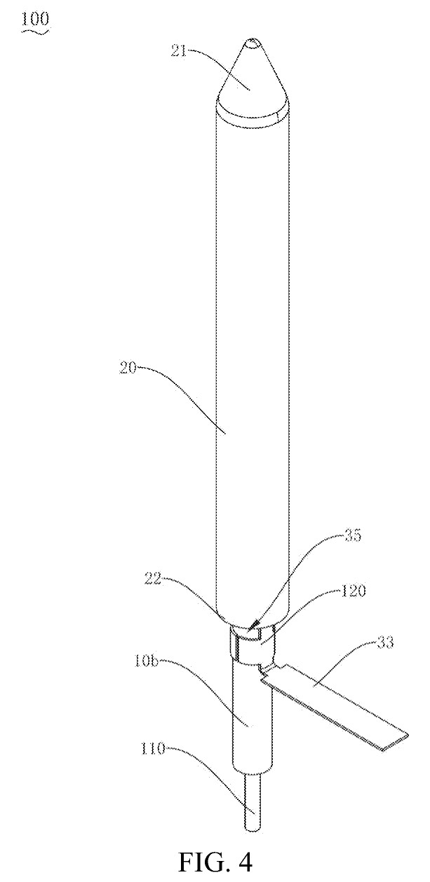

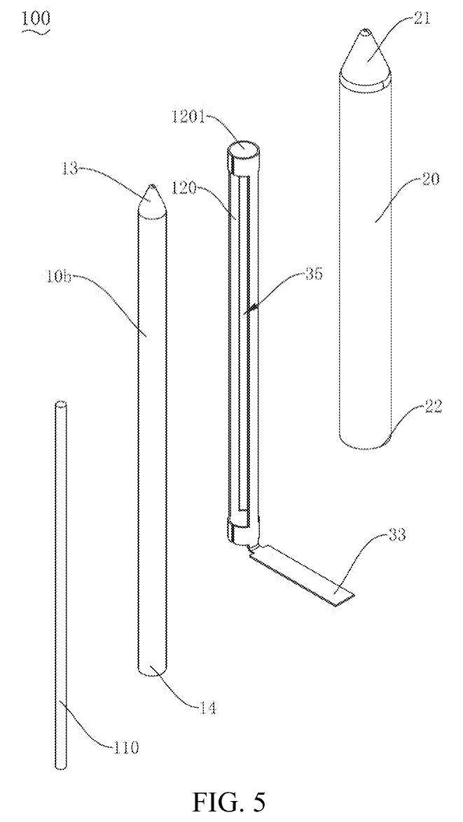

Referring to FIG. 2, FIG. 4, and FIG. 5, in an aspect, the insulating partition member 10b is a tube. The first electrode 110 is at least partially inserted into the insulating partition member 10b, and the second electrode 120 is located outside the insulating partition member 10b.

In this way, the insulating partition member 10b can block the first electrode 110 and the second electrode 120, to form a dielectric barrier discharge structure, to generate the plasma.

Specifically, the insulating partition member 10b may be a hollow tube. Relative to the outer tube 20, the insulating partition member 10b may be referred to as an inner tube. The first electrode 110 may be cylindrical, and is coaxial with the insulating partition member 10b. The first electrode 110 is inserted into the insulating partition member 10b, and the second electrode 120 is disposed on the tube wall of the insulating partition member 10b, so that the first electrode 110 and the second electrode 120 are separated by the tube wall of the insulating partition member 10b. The first electrode 110 and the second electrode 120 may be respectively connected to one pole of the high-voltage alternating current, and an alternating electric field is formed between the first electrode 110 and the second electrode 120. Under an effect of the alternating electric field, electrons in the working gas obtains sufficient energy to pass over the energy barrier of the insulating partition member 10b, and the working gas is ionized to form the plasma.

The first electrode 110 and the second electrode 120 may be disposed to have close end portion positions in the axial direction of the insulating partition member 10b, and have approximately equal lengths. A specific gap may exist between the first electrode 110 and the insulating partition member 10b in the radial direction of the insulating partition member 10b, or the first electrode 110 and the inner wall of the insulating partition member 10b may be tightly adhered to each other. A specific gap may exist between the second electrode 120 and the insulating partition member 10b, or may be tightly adhered to the outer wall of the insulating partition member 10b. For example, the second electrode 120 may be plated on the outer wall of the insulating partition member 10b.

The outer tube 20 may be sleeved outside the second electrode 120, and cover the insulating partition member 10b. Both the first electrode 110 and the second electrode 120 may extend out of the outer tube 20, and are connected to the power source 200.

The insulating partition member 10b may be made of a material having a relatively high insulating strength. For example, the insulating partition member 10b is made of a material such as quartz, glass, or ceramics. For another example, the insulating partition member 10b may be a quartz tube.

Referring to FIG. 2 and FIG. 5, in an aspect, the insulating partition member 10b includes a closed end 13 and an open end 14 opposite to the closed end 13, the closed end 13 is located in the outer tube 20, and the first electrode 110 is inserted into the insulating partition member 10b from the open end 14.

In this way, the closed end 13 may separate the first electrode 110 from the second electrode 120, thereby avoiding an arc generated by discharging between the first electrode 110 and the second electrode 120.

Specifically, the closed end 13 and the open end 14 may be the two ends of the insulating partition member 10b in the axial direction. The central axis of the insulating partition member 10b may pass through the open center of the open end 14, so that the first electrode 110 is inserted into the insulating partition member 10b from the open end 14, and is coaxial with the insulating partition member 10b. The closed end 13 of the insulating partition member 10b extends into the outer tube 20 and is located at one end of the outer tube 20 that is closed.

The outer tube 20 may be a hollow tube that is closed at one end and open at one end. The end of the outer tube 20 that is exposed is an exposed end 22, and the closed end may form a tapered end portion 21. The exposed end 22 and the closed end 13 may be axially opposite ends of the outer tube 20. The vertex of the tapered end portion 21 may be located on the central axis of the outer tube 20, and protrudes outward the outer tube 20. The closed end 13 of the insulating partition member 10b may be located at the tapered end portion 21 and slightly protrude toward the vertex of the tapered end portion 21. The shape of the closed end 13 may match the tapered end portion 21 to form a tapered shape.

The outer diameter of the tube-shaped insulating partition member 10b ranges from 1 mm to 1.5 mm, and the wall thickness ranges from 0.2 mm to 1 mm. For example, the outer diameter of the insulating partition member 10b may range from 1 mm to 1.5 mm, from 1.1 mm to 1.4 mm, from 1.2 mm to 1.3 mm, from 1.25 mm to 1.35 mm, or the like. For another example, the outer diameter of the insulating partition member 10b may be 1 mm, 1.1 mm, 1.2 mm, 1.4 mm, or 1.5 mm. The wall thickness of the insulating partition member 10b may range from 0.2 mm to 0.6 mm, from 0.3 mm to 0.5 mm, from 0.4 mm to 0.55 mm, or the like. For example, the wall thickness of the insulating partition member 10b is 0.2 mm, 0.3 mm, 0.4 mm, 0.6 mm, or the like. The size of the inner diameter of the insulating partition member 10b, that is, a difference between the outer diameter and the wall thickness of the insulating partition member 10b, is slightly greater than or equal to the diameter of the first electrode 110.

The diameter of the first electrode 110 ranges from 0.2 mm to 0.8 mm. For example, the diameter of the first electrode 110 may range from 0.2 mm to 0.8 mm, from 0.3 mm to 0.7 mm, from 0.4 mm to 0.6 mm, from 0.45 mm to 0.55 mm, or the like. For another example, the diameter of the first electrode 110 may be 0.2 mm, 0.4 mm, 0.5 mm, 0.6 mm, 0.7 mm, or 0.8 mm.

Referring to FIG. 2 and FIG. 5 again, in an aspect, the second electrode 120 is a tube, the second electrode 120 is sleeved outside the insulating partition member 10b, and the upper end surface of at least one of the first electrode 110 and the second electrode 120 is lower than the upper end surface of the insulating partition member 10b. In this way, the first electrode 110, the insulating partition member 10b, and the second electrode 120 may be sequentially nested, to form a pin-shaped heating structure. The structure is compact, facilitating apparatus miniaturization.

Specifically, the second electrode 120 may be coaxial with the insulating partition member 10b, and cover the outer wall of the insulating partition member 10b. The second electrode 120 may extend from the closed end 13 to the open end 14 of the insulating partition member 10b in the axial direction of the insulating partition member 10b. At the open end 14 of the insulating partition member 10b, the part of the second electrode 120 may be exposed outside the outer tube 20.

It needs to be noted that in this disclosure, it is defined that a direction pointing from one closed end of the outer tube 20 to one end of the outer tube 20 that has an opening in the axial direction of the outer tube 20 is an up-to-down direction.

The second electrode 120 is sleeved outside the insulating partition member 10b, and the insulating partition member 10b is sleeved outside the first electrode 110, so that the insulating partition member 10b may partition the first electrode 110 and the second electrode 120. The first electrode 110, the insulating partition member 10b, and the second electrode 120 may be jointly inserted into the outer tube 20. The end surfaces of the first electrode 110, the insulating partition member 10b, and the second electrode 120 in the outer tube 20 closest to the tapered end portion 21 are the upper end surfaces. One of upper end surfaces of the first electrode 110 and the second electrode 120 is lower than the upper end surface of the insulating partition member 10b, or the upper end surfaces of the first electrode 110 and the second electrode 120 are both lower than the upper end surface of the insulating partition member 10b, so that the upper end surface of the first electrode 110 and the upper end surface of the second electrode 120 may be blocked by the insulating partition member 10b (to avoid a plasma arc generated between the upper end surfaces of the first electrode 110 and the second electrode 120), thereby generating the dielectric barrier discharge.

The second electrode 120 may be made of a material having high electrical conduction, for example, a metal material such as stainless steel, or nickel and nickel alloy.

The outer tube 20 covers outside the second electrode 120. A specific gap may be maintained between the inner wall of the outer tube 20 and the outer peripheral surface of the second electrode 120. The inner wall of the outer tube 20 may alternatively be in contact with the outer peripheral surface of the second electrode 120.

For example, the first electrode 110, the insulating partition member 10b, the second electrode 120, and the outer tube 20 are sequentially nested to form a pin-shaped heating assembly 100. The first electrode 110, the insulating partition member 10b, the second electrode 120, and the outer tube 20 may be approximately coaxial. The pin-shaped heating assembly 100 may be inserted, in the axial direction of the heating assembly 100, into the aerosol generating substrate 300 from the tapered end portion 21 of the outer tube 20. The outer wall of the outer tube 20 is in direct contact with the aerosol generating substrate 300.

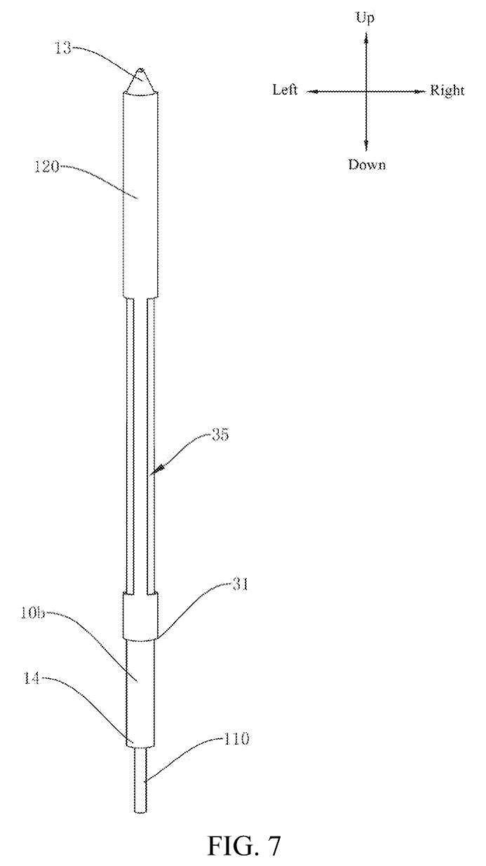

Referring to FIG. 5 and FIG. 7, in an aspect, the second electrode 120 has a center hole 1201 running through the two ends of the second electrode 120 in the axial direction of the second electrode 120, and the insulating partition member 10b extends in the center hole 1201.

Specifically, the second electrode 120 may be a through-tube coaxial with the first electrode 110 and the insulating partition member 10b. In the axial direction of the second electrode 120, the insulating partition member 10b is inserted into the second electrode 120 from the center hole 1201 of one end of the second electrode 120, and extends out of the second electrode 120 from the center hole 1201 of the other end. The closed end 13 and the open end of the insulating partition member 10b may be exposed to the outside of the second electrode 120 from the center holes 1201 at the two ends of the second electrode 120.

In an aspect, the outer diameter of the through-tube of the second electrode 120 ranges from 1.0 mm to 2.0 mm, and the wall thickness ranges from 0.05 mm to 0.3 mm.

For example, the outer diameter of the second electrode 120 may range from 1.0 mm to 1.9 mm, from 1.1 mm to 1.8 mm, from 1.2 mm to 1.8 mm, from 1.3 mm to 1.6 mm, from 1.4 mm to 1.5 mm, or the like, and the wall thickness of the second electrode 120 may range from 0.05 mm to 0.3 mm, from 0.06 mm to 0.28 mm, from 0.07 mm to 0.25 mm, from 0.08 mm to 0.24 mm, from 0.12 mm to 0.20 mm, from 0.14 mm to 0.16 mm, or the like.

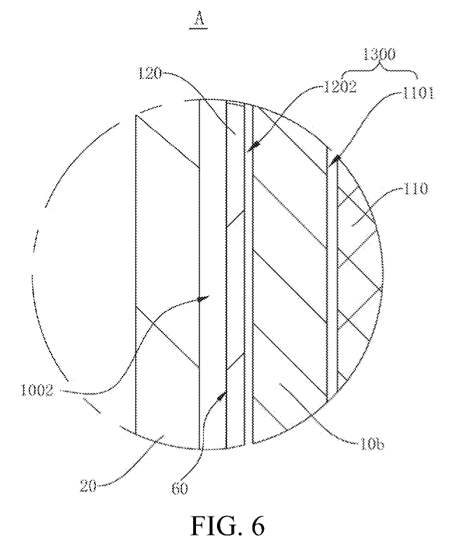

For another example, the outer diameter of the second electrode 120 may be 1.0 mm, 1.2 mm, 1.3 mm, 1.5 mm, 1.7 mm, or 2.0 mm, and the wall thickness of the second electrode 120 may be 0.05 mm, 0.08 mm, 0.10 mm, 0.15 mm, 0.21 mm, 0.25 mm, or 0.3 mm. The inner diameter of the second electrode 120, that is, a difference between the outer diameter and the wall thickness of the second electrode 120, may be slightly greater than or equal to the outer diameter of the insulating partition member 10b. Referring to FIG. 2 and FIG. 6, in an aspect, the insulating partition member 10b may be a hollow tube, and is sleeved outside the first electrode 110. The insulating partition member 10b extends into one end of the outer tube 20 and is closed, and the second electrode 120 is sleeved outside the insulating partition member 10b. The first electrode 110, the insulating partition member 10b, and the second electrode 120 may have approximately the same central axis, and the radii sequentially increase. The inner diameter of the insulating partition member 10b is slightly greater than the diameter of the first electrode 110, and the inner diameter of the second electrode 120 is slightly greater than the outer diameter of the insulating partition member 10b. Therefore, the first gap 1101 is formed between the first electrode 110 and the insulating partition member 10b, and the second gap 1202 is formed between the second electrode 120 and the insulating partition member 10b.

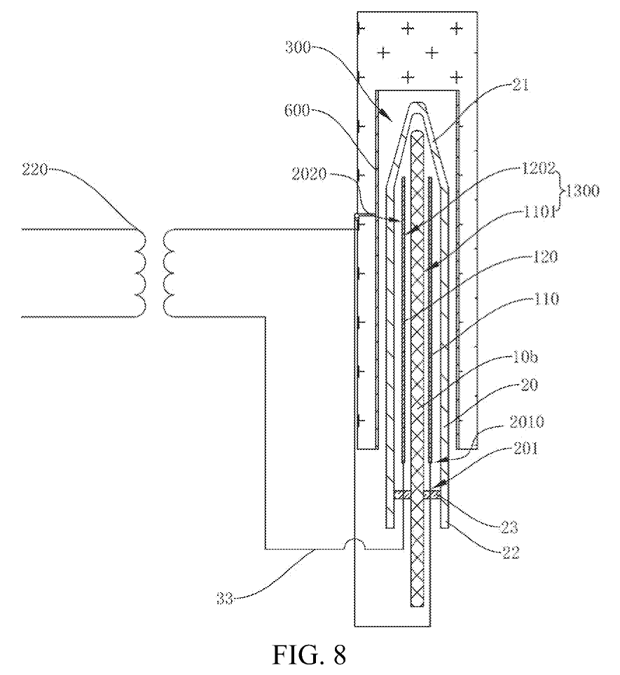

Referring to FIG. 8, in an aspect, the insulating partition member 10b may be a plate, and the first electrode 110 is disposed on one side of the insulating partition member 10b. A specific distance is maintained between the side surface of the insulating partition member 10b facing the first electrode 110 and the first electrode 110, and forms the first gap 1101. The second electrode 120 is disposed on the side facing away from the first electrode 110. A specific distance exists between the side surface of the insulating partition member 10b facing the second electrode 120 and the second electrode 120, and forms the second gap 1202.

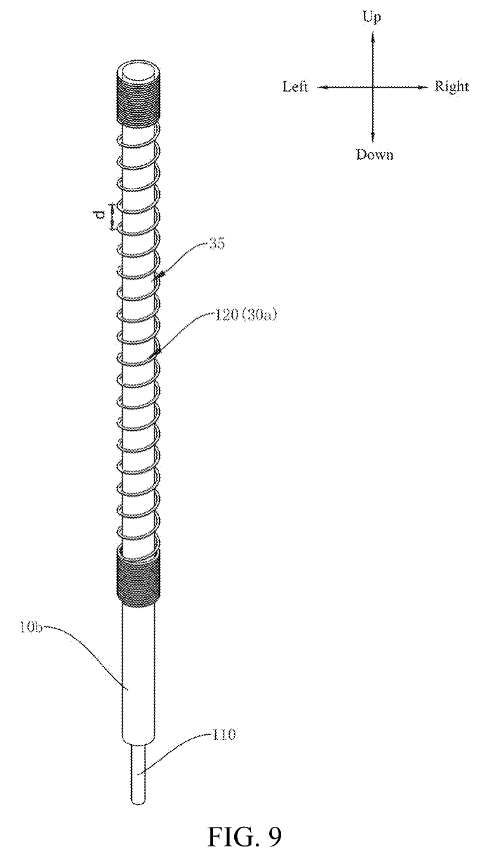

Referring to FIG. 4, FIG. 7, and FIG. 9, in an aspect, a hollowed-out portion 35 is formed on the second electrode 120, and the hollowed-out portion 35 enables the insulating partition member 10b to partially face the outer tube 20 through the hollowed-out portion 35.

In this way, the second electrode 120 can adjust distribution of the plasma by using the hollowed-out portion 35, to further adjust and control a temperature field of the heating assembly 100.

Specifically, the second electrode 120 may form the hollowed-out portion 35 by using a cut groove, a spiral structure, or the like. For example, referring to FIG. 7, the second electrode 120 is a tube, and the hollowed-out portion 35 is formed by cutting on the tube wall. For another example, referring to FIG. 9, the second electrode 120 is a wire, and winds and extended in the axial direction of the insulating partition member 10b, to form a solenoid 30a. At least the partial pitch d of the solenoid 30a is greater than 0, to form the hollowed-out portion 35. It needs to be noted that the plasma is mainly formed in a region in which the first electrode 110 and the second electrode 120 are opposite, so that the temperature of the region in which the first electrode 110 and the second electrode 120 are opposite is relatively high, and heat is relatively concentrated. The direction from the tapered end portion 21 to the exposed end 22 of the outer tube 20 may be the up-to-down direction, and the outer tube 20 is inserted into the aerosol generating substrate 300 from the tapered end portion 21. the region in which the first electrode 110 and the second electrode 120 are opposite may be close to the tapered end portion 21 of the outer tube 20, to facilitate heating the aerosol generating substrate 300. The hollowed-out portion 35 may be mainly distributed in an interval below the region in which the first electrode 110 and the second electrode 120 are opposite, to reduce downward transmission of heat, and improve heat utilization of the aerosol generating substrate 300.

In an aspect, the hollowed-out portion 35 may alternatively be distributed in the region in which the first electrode 110 and the second electrode 120 are opposite. The plasma is not generated between the position at which the hollowed-out portion 35 of the second electrode 120 is located and the first electrode 110, and the plasma may be still formed at the position at which the second electrode 120 is hollowed out and that is opposite to the first electrode 110. Therefore, different hollowed-out portion 35 may be designed according to requirements, and different plasma and temperature distributions may be further designed.

For example, referring to FIG. 9 again, the pitches of the upper and lower ends of the solenoid 30a are smaller than the pitch d of the middle part, so that the area of the hollowed-out portion 35 at the middle part is larger, heat is relatively more easily dissipated, and the temperature of the middle part is relatively low.

In an aspect, the wall thickness of the insulating partition member 10b ranges from 0.2 mm to 1 mm.

In this way, the insulating partition member 10b can prevent the arc from being generated between the first electrode 110 and the second electrode 120, and has the specific support strength and impact resistance.

Specifically, the insulating partition member 10b may be a tube, and the wall thickness of the tube wall ranges from 0.2 mm to 0.6 mm. The insulating partition member 10b may alternatively be a plate, and the wall thickness of the plate ranges from 0.2 mm to 0.6 mm. For example, the wall thickness of the insulating partition member 10b may range from 0.2 mm to 0.6 mm, from 0.3 mm to 0.5 mm, from 0.4 mm to 0.5 mm, from 0.55 mm to 0.6 mm, or the like. For another example, the wall thickness of the insulating partition member 10b may be 0.2 mm, 0.3 mm, 0.4 mm, 0.5 mm, or 0.6 mm.

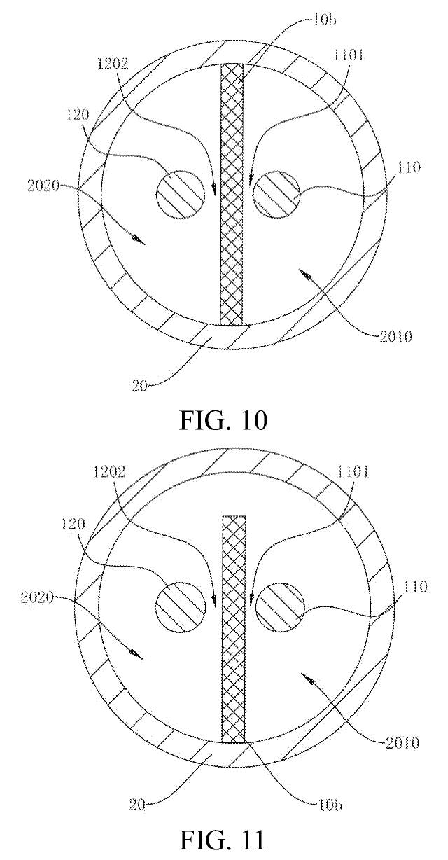

Referring to FIG. 8 and FIG. 10 again, in an aspect, the insulating partition member 10b may be a plate. The insulating partition member 10b extends into the outer tube 20. One end is close to the tapered end portion 21, and extends from the tapered end portion 21 in the axial direction of the outer tube 20 to the exposed end 22 of the outer tube 20. The other end is partially exposed out of the outer tube 20 from the exposed end 22. The insulating partition member 10b divides the inside of the outer tube 20 into a first interval 2010 and a second interval 2020. The first electrode 110 is at least partially located in the first interval 2010, and the second electrode 120 is at least partially located in the second interval 2020.

The first electrode 110 may be cylindrical, and extends in the first interval 2010 separately. The second electrode 120 may be cylindrical, and extends in the second interval 2020. The first electrode 110 and the second electrode 120 may both be a metal wire.

The first electrode and/or the second electrode may alternatively be long plate-shaped. The first electrode 110 and the second electrode 120 may both be a metal plate electrode, and respectively extend in the first interval 2010 and the second interval 2020. The plate-shaped first electrode 110 and second electrode 120 may be approximately parallel.

In an aspect, referring to FIG. 10, the insulating partition member 10b is embedded into the outer tube 20, and the formed first interval 2010 and second interval 2020 are relatively closed in the outer tube 20. The width of the insulating partition member 10b in the radial direction of the outer tube 20 is approximately equal to the diameter of the outer tube 20, so that the insulating partition member 10b abuts against two opposite sides of the inner wall of the outer tube 20 in the radial direction of the outer tube 20. The insulating partition member 10b may extend in the axial direction of the outer tube 20. One end abuts against the inner wall of the tapered end portion 21, and the other end extends out of the outer tube 20 from the exposed end 22.

In an aspect, referring to FIG. 11, the width of the insulating partition member 10b in the radial direction of the outer tube 20 is slightly less than the diameter of the outer tube 20, and the insulating partition member 10b has at least one side abutting against the inner wall of the outer tube 20 in the radial direction of the outer tube 20. The insulating partition member 10b divides the outer tube 20 into the first interval 2010 and the second interval 2020 that are in communication with each other.

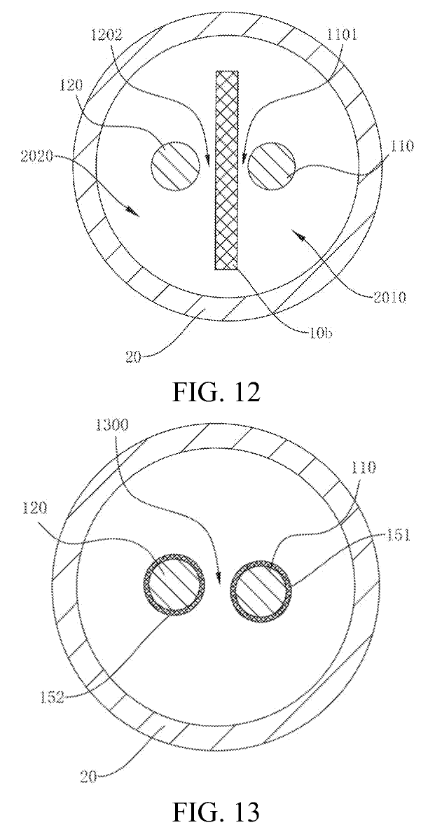

In an aspect, referring to FIG. 12, a specific distance is kept between both two sides of the insulating partition member 10b in the radial direction of the outer tube 20 and the inner wall of the outer tube 20, and the insulating partition member 10b is suspended in the outer tube 20. The insulating partition member 10b divides the outer tube 20 into the first interval 2010 and the second interval 2020 that are in communication with each other.

In an aspect, the insulating partition member 10b may be tube-shaped, and cover the outer surface of at least one of the first electrode 110 and the second electrode 120.

Referring to FIG. 13, in an aspect, the insulating partition member 10b includes a first insulating partition member 151 and a second insulating partition member 152, the first insulating partition member 151 wraps the first electrode 110, the second insulating partition member 152 wraps the second electrode 120, and the first electrode 110 and the second electrode 120 are disposed in parallel.

In this way, the gap 1300 is formed between the first electrode 110 and the second insulating partition member 152 and between the second electrode 120 and the first insulating partition member 151, and the plasma is generated in the gap 1300 and releases heat.

Specifically, the first insulating partition member 151 and the second insulating partition member 152 may be made of a flexible insulating material having a low rigidity. For example, the first electrode 110 is wrapped with rubber, an insulating tape, or the like to form the first insulating partition member 151, and the second electrode 120 is wrapped to form the second insulating partition member 152.

In this embodiment, the first electrode 110 and the second electrode 120 may both be cylindrical. For example, two parallel metal wires are disposed in the outer tube 20 to serve as the first electrode 110 and the second electrode 120. The first electrode 110 and the second electrode 120 may alternatively be plate-shaped, and relatively wide surfaces of the first electrode 110 and the second electrode 120 are opposite. For example, two parallel metal plates are disposed in the outer tube to serve as the first electrode 110 and the second electrode 120. Alternatively, one of the first electrode 110 and the second electrode 120 may be cylindrical, and the other may be plate-shaped.

In an aspect, the first insulating partition member 151 covers the first electrode 110, the second electrode 120 is parallel to the first electrode 110, the gap 1300 is formed between the second electrode 120 and the first insulating partition member 151, and the outer surface of the second electrode 120 is not covered by an insulating element.

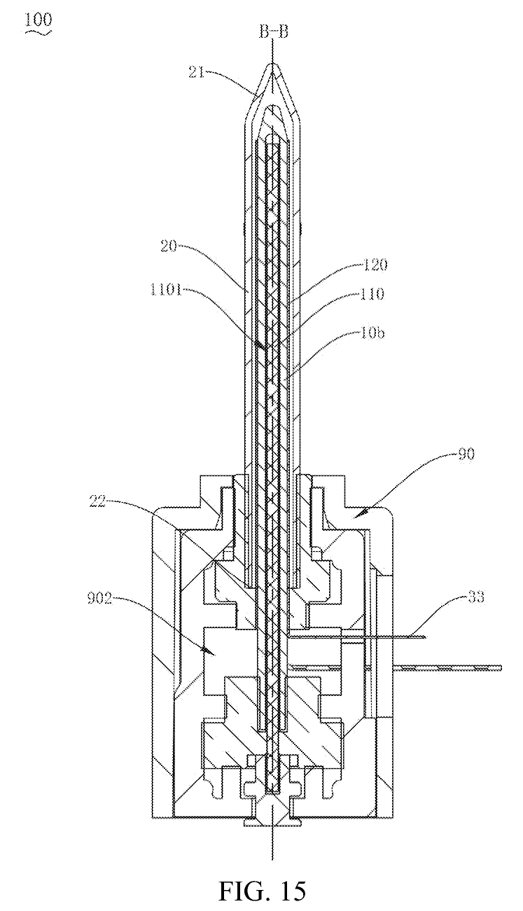

In an aspect, the second insulating partition member 152 covers the second electrode 120, the first electrode 110 and the second electrode 120 are disposed in parallel, the gap 1300 is formed between the first electrode 110 and the second insulating partition member 152, and the outer surface of the first electrode 110 may not be covered by an insulation element. Referring to FIG. 15, in an aspect, the second electrode 120 is adhered to the insulating partition member 10b.

In an aspect, the second electrode 120 is adhered to the inner wall of the outer tube 20.

In this way, the second electrode 120 is clearly limited, is assembled compactly, and is easy to mount.

In an aspect, the second electrode 120 may be a thin-walled tube, and is sleeved outside the insulating partition member 10b. The outer tube 20 is sleeved outside the second electrode 120. The tube wall of the second electrode 120 may be adhered to the outer peripheral surface of the insulating partition member 10b, or may be tightly adhered to the inner wall of the outer tube 20.

In an aspect, the second electrode 120 may be a metal film, a semiconductor film, or a coating. The second electrode 120 may be plated or coated on the insulating partition member 10b, to cover the surface of the side of the insulating partition member 10b facing the outer tube 20. The second electrode 120 may alternatively be plated or coated on the inner wall of the outer tube 20.

In an aspect, the first electrode 110 and the second electrode 120 may control the temperature of the outer tube 20 by adjusting plasma output power.

Referring to FIG. 6 again, in an aspect, the heating assembly 100 includes an infrared radiation film 60, and the infrared radiation film 60 is disposed on at least one of the insulating partition member 10b, the outer tube 20, the first electrode 110, and the second electrode 120.

In this way, a capability of the heating assembly 100 to heat through infrared radiation can be enhanced.

Specifically, the infrared radiation film 60 may be a coating attaching to the insulating partition member 10b, the inner wall or the outer wall surface of the outer tube 20, and/or the surface of the side of the second electrode 120 facing away from the insulating partition member 10b. A coating material of the infrared radiation film 60 may be a material that can specifically absorb infrared radiation, such as a metal oxide or silicon.

For example, the infrared radiation film 60 may be a film made of one or more of materials such as iron-manganese-copper oxide, CrC, TiCN, diamond-like carbon (DLC) thin film, black silicon (HBQ), cordierite, transition metal oxide series spinel, rare earth oxide, ion co-doped calcium ore, silicon carbide, zircon, and boron nitride. The infrared radiation film 60 for absorbing radiation in different wavebands may be made by using different materials.

In an aspect, the infrared radiation film 60 is plated on the surface of the side of the second electrode 120 facing the outer tube 20.

In an aspect, the infrared radiation film 60 is coated on the inner wall surface of the outer tube 20.

Referring to FIG. 2 and FIG. 4 again, in an aspect, in the axial direction of the outer tube 20, the heights of the ends of the first electrode 110, the insulating partition member 10b, and the second electrode 120 that face the same side sequentially increase.

In this way, the positions at which the first electrode 110 and the second electrode 120 are connected to the power source 200 can be staggered, and the insulation strength of an interval at which the first electrode 110 and the second electrode 120 are connected to the power source 200 can be improved.

Specifically, in the axial direction of the outer tube 20, the direction from the closed tapered end portion 21 to the exposed end 22 may be the up-to-down direction. The first electrode 110, the second electrode 120, and the insulating partition member 10b may extend from an exposed opening at the lower end of the outer tube 20 until the extending end abuts against the inner wall of the tapered end portion 21. The heights of the end portions of the first electrode 110, the insulating partition member 10b, and the second electrode 120 close to the exposed end 22 sequentially increase. The lower end surface of the insulating partition member 10b is located between the lower end surface of the first electrode 110 and the lower end surface of the second electrode 120, so that the insulating strength can be improved. The second electrode 120 may not extend out of the outer tube 20, and the insulating partition member 10b and the first electrode 110 extend out of the outer tube 20 from the exposed end 22. The lower end surface of the outer tube 20 may be located above the lower end surface of the second electrode 120, to facilitate external wire leading of the second electrode 120.

In an aspect, the outer diameter of the outer tube 20 ranges from 1.5 mm to 2.6 mm, and the wall thickness of the outer tube 20 ranges from 0.3 mm to 0.5 mm.

For example, the outer diameter of the outer tube 20 may range from 1.5 mm to 2.6 mm, from 1.6 mm to 2.5 mm, from 1.7 mm to 2.4 mm, from 1.8 mm to 2.2 mm, from 2.0 mm to 2.15 mm, or the like. The wall thickness of the outer tube 20 may range from 0.3 mm to 0.5 mm, from 0.32 mm to 0.48 mm, from 0.36 mm to 0.45 mm, from 0.39 mm to 0.43 mm, or the like.

For another example, the outer diameter of the outer tube 20 may be 1.5 mm, 1.8 mm, 2.0 mm, 2.15 mm, 2.3 mm, 2.6 mm, or the like. The wall thickness of the outer tube 20 may be 0.31 mm, 0.32 mm, 0.33 mm, 0.37 mm, 0.41 mm, 0.44 mm, 0.5 mm, or the like.

Still referring to FIG. 2 and FIG. 4, in an aspect, sizes of the first electrode 110, the insulating partition member 10b, and the second electrode 120 that extend out of the outer tube 20 sequentially decrease.

In this way, it is convenient for the first electrode 110 and the second electrode 120 to lead wires to the power source 200, and it is ensured that wires of the first electrode 110 and the second electrode 120 do not overlap to cause breakdown.

Specifically, the first electrode 110 and the second electrode 120 may both extend out from the exposed end 22, and are connected to the power source 200 by using a power connection wire 33.

The first electrode 110, the insulating partition member 10b, and the second electrode 120 partially extend out of the outer tube 20 through the exposed end 22 of the outer tube 20. The lower end surface of the insulating partition member 10b is located between the lower end surface of the first electrode 110 and the lower end surface of the second electrode 120. The size of the end portion of the first electrode 110 exposed outside the outer tube 20 is greater than the size of the end portion of the exposed insulating partition member 10b, and both are greater than the size of the exposed end of the second electrode 120.

Referring to FIG. 2 and FIG. 8, in an aspect, the heating assembly 100 includes a sealing member 23, the sealing member 23 is sealedly connected to the inner wall of the outer tube 20 and forms a first enclosed space 201 with the outer tube 20, the first enclosed space is filled with a working gas, and the first electrode 110 and/or the second electrode 120 is at least partially located in the first enclosed space 201.

In this way, harmful gases generated from discharging can be prevented from escaping, and an odor of the discharging can be isolated.

Specifically, the tapered end portion 21 of the outer tube 20 is inserted into the aerosol generating substrate 300, and the outer tube 20 heats the aerosol generating substrate 300. The first electrode 110, the second electrode 120, and the insulating partition member 10b at least partially extend into the outer tube 20, and the plasma is generated in the outer tube 20. The tapered end portion 21 and the sealing member 23 close the inside of the outer tube 20, to form the first enclosed space 201. The plasma is generated in the closed first enclosed space 201, escaped odor of the discharging can be reduced, and a passage through which the working gas is charged and an exhaust gas is discharged can be separated from an airway (not shown in the figure) for inhaling the aerosol, thereby avoiding inhalation of the harmful gases generated from discharging.

For example, at the exposed end 22 of the outer tube 20, the sealing member 23 is formed by applying adhesive between the second electrode 120 and the outer tube 20, between the insulating partition member 10b and the outer tube 20, and between the first electrode 110 and the insulating partition member 10b.

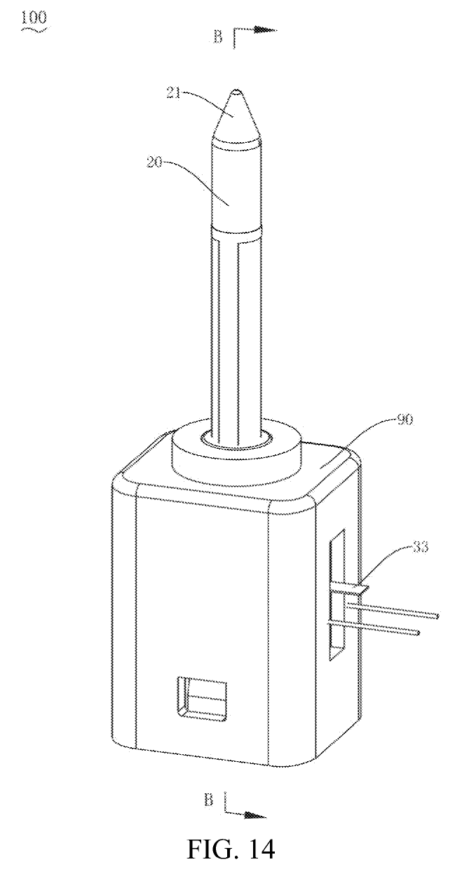

Referring to FIG. 14 and FIG. 15, in an aspect, the heating assembly 100 includes a base 90. A second enclosed space 902 is formed in the base 90, and the part of the first electrode 110 located outside the first enclosed space 201 and/or the end of the outer tube 20 having an opening is located in the second enclosed space 902.

In the base 90, the first electrode 110 and an electrical conduction element such as a conducting wire in the base 90 may also form a harmful gas such as ozone. Therefore, the second enclosed space 902 can further prevent the harmful gas that is generated from discharging from escaping.

Specifically, the heating assembly 100 is mounted on the base 90. The exposed end 22 of the outer tube 20, that is, the end of the outer tube 20 having an opening, may be inserted into the base 90. The first electrode 110, the second electrode 120, and the insulating partition member 10b may partially extend out of the opening of the exposed end 22 and extend into the base 90. The base 90 is assembled in a sealed manner to the wall of the outer tube 20, the first electrode 110, the second electrode 120, and the insulating partition member 10b.

For example, the base 90 may be sealed by applying adhesive.

It needs to be noted that when the working gas is air, in a process of plasma generation, a side reaction in which oxygen is ionized to generate ozone occurs. Inside of the outer tube 20, the plasma is generated between the insulating partition member 10b and the first electrode 110 and/or between the insulating partition member 10b and the second electrode 120. Therefore, a substance absorbing ozone may be coated on the inner wall of the outer tube 20 and the insulating partition member 10b, to prevent ozone from escaping. In the base 90, ozone may also be formed at the first electrode 110 and the electrical conduction element such as the conducting lead in the base 90, and the substance absorbing ozone may be coated on both the inner wall of the base 90 and the element in the base 90.

In an aspect, the working gas is nitrogen, argon, carbon dioxide, or the like. The base 90 is sealed to the outer tube 20, to prevent the working gas from being lost.

Referring to FIG. 3, an aerosol generating device 1000 in the examples of this disclosure includes the heating assembly 100 according to any one of the foregoing examples. Specifically, the aerosol generating device 1000 may include a battery 210, a PCBA board 410, a control circuit 420, a transformer 220, the heating assembly 100, a cover body 500, and the like.

In an embodiment, the battery 210 and the transformer 220 may form the power source 200 of the heating assembly 100. The PCBA board and the control circuit may form a control center, and are configured to adjust and control power output by an external power source to the first electrode and the second electrode, to further adjust and control heating power of the heating assembly.

With reference to FIG. 1, the first electrode 110 and the second electrode 120 are respectively connected to one pole of the transformer 220. A high-voltage alternating current is conducted, and a high-strength alternating electric field is formed in the outer tube 20, thereby forming the plasma, and generating high temperature and heat. The heating assembly 100 is connected to the cover body 500, the outer tube 20 is inserted into the aerosol generating substrate 300, and heat of the plasma is transferred to the aerosol generating substrate 300 through the inner tube 10 and the outer tube 20. The aerosol generating substrate 300 absorbs the heat, to be atomized to form an aerosol.

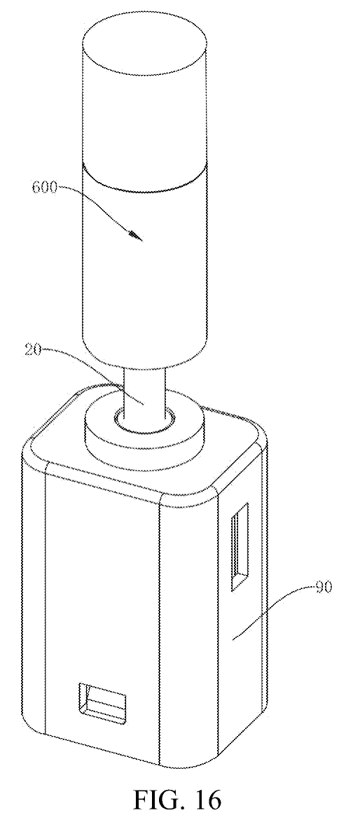

Referring to FIG. 3 and FIG. 16, in an aspect, the aerosol generating device 1000 includes a cleaning assembly 600. The cleaning assembly 600 may generate plasma, to remove residue impurities after the aerosol generating substrate 300 absorbs the heat to generate the aerosol.

### Example 2:

Referring to FIG. 1 to FIG. 3, the aerosol generating device 1000 according to an example of this disclosure includes the heating assembly 100 and the cleaning assembly 600. The heating assembly 100 includes an outer tube 20 and a heat generation mechanism 1100 disposed in the outer tube 20. The cleaning assembly 600 includes a hollow member 610 and an electrode 620, where the hollow member 610 is detachably sleeved outside the outer tube 20, the electrode 620 is disposed between the hollow member 610 and the outer tube 20 and forms a gap with the outer wall 2001 of the outer tube 20, and the electrode 620 is configured to generate plasma in the gap.

For ease of description, the gap formed between the electrode 620 that is disposed between the hollow member 610 and the outer tube 20 and the outer wall 2001 of the outer tube 20 is a cleaning gap 603.

According to the aerosol generating device 1000 in this example of this disclosure, the plasma generated between the hollow member 610 and the outer tube 20 by the electrode 620 heats and cleans aerosol residues attaching to the outer tube 20, thereby improving efficiency of heating the aerosol generating substrate 300 by the heating assembly 100.

Specifically, referring to FIG. 1 and FIG. 2, the outer tube 20 may be a hollow tube, and have an exposed opening at one end, and the end having the exposed opening is an exposed end 22. The heat generation mechanism 1100 may be inserted into the outer tube 20 from the exposed opening of the outer tube 20, so that the outer tube 20 at least partially wraps the heat generation mechanism 1100. The outer tube 20 may be inserted into the aerosol generating substrate 300, to come into direct contact with the aerosol generating substrate 300. The end of the outer tube 20 inserted into the aerosol generating substrate 300 may be closed. The end of the outer tube 20 that is closed may protrude relatively sharply outward, to form a tapered end portion 21. The cross-sectional shape of the outer tube 20 includes, but is not limited to, a circle, an ellipse, and the like.

The heat generation mechanism 1100 may be a heating mechanism heats by using plasma, resistance, and/or electromagnetic induction. The heat generation mechanism 1100 is at least partially located inside the outer tube 20. Heat generated by the heat generation mechanism 1100 is transferred to the aerosol generating substrate 300 through the outer tube 20. The aerosol generating substrate 300 absorbs sufficient heat, and is atomized outside the outer tube 20 to form the aerosol. The aerosol generated by the aerosol generating device 1000 may be used for consumption, assistance in drug inhalation, and the like.

The outer tube 20 may be made of a material such as quartz, quartz glass, or ceramics, so that the outer tube 20 is transparent to the infrared radiation, improves the efficiency of heating the aerosol generating substrate 300, and provides insulation protection for the heat generation mechanism 1100.

In a process in which the heating assembly 100 heats the aerosol generating substrate 300, the temperature of the aerosol generating substrate 300 may reach a temperature for atomization to form the aerosol, but does not exceed an ignition point of the aerosol generating substrate 300. Therefore, in a process in which the aerosol generating device 1000 generates the aerosol, the aerosol generating substrate 300 may not combust.

In a state in which the aerosol generating device 1000 generates the aerosol, the aerosol generating substrate 300 is heated by the outer tube 20 to form the aerosol, and the formed aerosol may escape out of the aerosol generating device 1000 through an aerosol inhalation airway (not shown in the figures). To end generation of the aerosol by the aerosol generating device 1000, the heating assembly 100 needs to stop heating and cool down. In a process of cooling the heating assembly 100, the aerosol that does not completely escape out of the aerosol generating device 1000 may remain and attach to the outer wall 2001 of the outer tube 20. Residues attaching to the outer tube 20 easily reduce the efficiency of heating the aerosol generating substrate 300 by the outer tube 20.

The heating assembly 100 may be partially inserted into the cleaning assembly 600 when the aerosol generating device 1000 is in a cleaning state, as shown in FIG. 16. In the axial direction of the outer tube 20, the direction from the tapered end portion 21 to the exposed end 22 may be an up-to-down direction. The hollow member 610 may cover the outer periphery of the outer tube 20 from top to bottom. In other words, the heating assembly 100 is inserted into the hollow member 610 of the cleaning assembly 600 from bottom to top.

In an aspect, the hollow member 610 may be a part of the aerosol generating device 1000, and plays a role of strengthening support, mounting and fixing, or acting as a cover body, or acting as an extractor (a mechanism for taking out the aerosol generating substrate 300). For example, the hollow member 610 may be integrated with the cover body 500, or the hollow member 610 may be integrated with the cleaning assembly 600, or the hollow member 610 may be integrated with the extractor.

The cleaning assembly 600 may alternatively be an attached apparatus or an additional apparatus of the aerosol generating device 1000, and is assembled to the aerosol generating device 1000 only when cleaning is required.

The outer tube 20 is at least partially accommodated in a hollow of the hollow member 610. The hollow member 610 may be cylindrical. The cross-sectional shape of the hollow member 610 may include, but is not limited to, a circle, a near circle, an ellipse, a square, or the like, and may match the cross-sectional shape of the outer tube 20. The depth of the hollow in the hollow member 610 may match the length of the outer tube 20 inserted into the hollow member 610.

The hollow member 610 is sleeved outside the outer tube 20, and a specific distance is maintained between the inner surface of the hollow member 610 and the outer wall 2001 of the outer tube 20. In other words, the hollow member 610 is not in direct contact with the outer tube 20. In an aspect, the hollow member 610 may be in direct contact with the outer tube 20 provided that a gas is allowed to enter between the hollow member 610 and the outer tube 20.

The aerosol generating substrate 300 may wrap around the outer tube 20, and a residual generated from generation of the aerosol may cool and deposit on the outer wall 2001 of the outer tube 20. The residual may be some organic materials having relatively strong adherence. The heating assembly 100 is inserted into the cleaning assembly 600, and the residual may alternatively remain at another position in the cleaning gap 603.

In some related technologies, a core element of the heating assembly such as the outer tube is easily damaged by cleaning the heating assembly through physical brushing, and it is difficult to achieve a clean cleaning effect.

Referring to FIG. 1 again, in this example of this disclosure, the electrode 620 is disposed on the surface of the side of the hollow member 610 facing the outer tube 20.

At least the cleaning gap 603 is provided between the electrode 620 and the outer wall of the outer tube 20. A voltage at a specific strength is applied to the electrode 620 and another electrode opposite to the electrode 620, and the electrode 620 may discharge in the cleaning gap 603 to generate the plasma. In some other embodiments, the electrode 620 may be disposed outside the inner surface of the hollow member 610. That is, at least one insulating layer may be further disposed between the electrode 620 and the outer tube 20. It may be understood that the another electrode may be an electrode used for generating heat by the heating assembly 100, or may be another electrode added in the outer tube 20.

The cleaning assembly 600 may process and decompose the residual into small molecules, such as a volatile organic substance, light oxide, and water vapors, by using the plasma generated in the cleaning gap 603. A decomposition product of a small molecule may be volatilized in a form of a gas. In this way, the cleaning assembly 600 can clean the aerosol residual on the outer wall 2001 of the outer tube 20, thereby improving the efficiency of heating the aerosol generating substrate 300 when the heating assembly 100 is used again, and facilitating generation of the aerosol. In addition, the cleaning assembly 600 cleans the outer tube 20 by using the plasma, damage to elements is not easily caused, the temperature increases rapidly, and may quickly reach more than 500 degrees centigrade, the elements are easy to be cleaned. Because a heat capacity is relatively small, a cooling speed is fast, so that an impact on a function of the power source or the control center caused by an excessively high temperature increase of an appliance is avoided. In addition, the cleaning temperature is relatively easy to be controlled, and has little impact on reliability of the heating assembly 100.

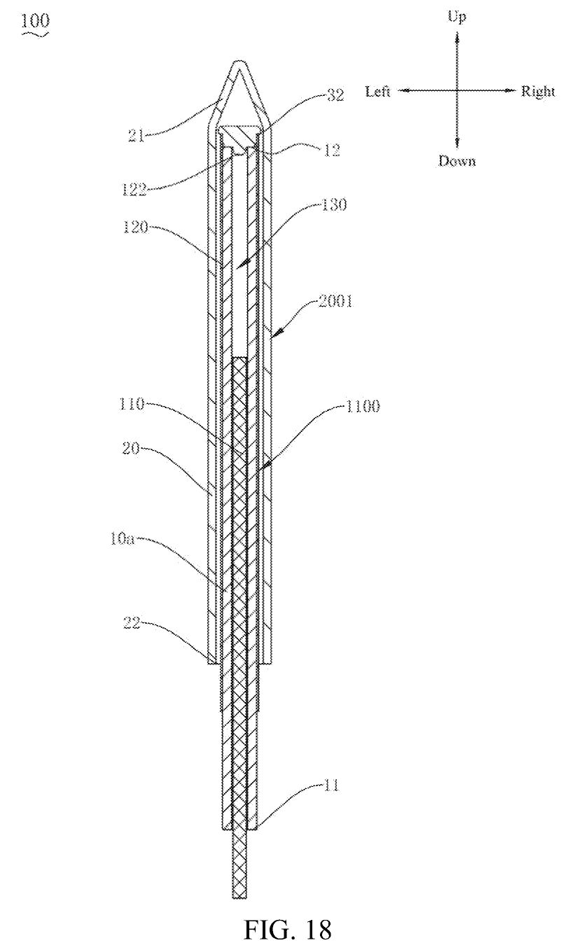

Referring to FIG. 2 and FIG. 18, in an aspect, the heat generation mechanism 1100 includes a first electrode 110 and a second electrode 120, the first electrode 110 and the second electrode 120 are both at least partially disposed in the outer tube 20, the first electrode 110 and the second electrode 120 are opposite disposed and are spaced apart, and the plasma is generated between the first electrode 110 and the second electrode 120 when the first electrode 110 and the second electrode 120 are energized.

In this way, the heat generation mechanism 1100 may radiate a large amount of heat to the outside through a process of plasma generation and a high temperature of the plasma, to heat the aerosol generating substrate 300.

The plasma is a material form that includes a large quantity of charged particles and neutral atoms and molecules, and keeps charge neutral as a whole. Under an effect of an electric field, a gas may be ionized to generate plasma. A large amount of heat can be generated in a process of plasma generation, and the temperature of the plasma in a stable state may reach above 1000 °C. According to the aerosol generating device 1000 in this example of this disclosure, the aerosol generating substrate 300 may be heated by using the high temperature in the process of plasma generation and the high temperature of the plasma, to generate the aerosol. The generated aerosol may be smoked through a suction nozzle.

The heat generation mechanism 1100 may include an inner tube 10a. The inner tube 10a may be a hollow tube. The first electrode 110 may be cylindrical, and is partially inserted into the inner tube 10a. The second electrode 120 may be hollow tube-shaped, and is sleeved outside the inner tube 10a. The inner tube 10a may be made of a material having high insulation strength, for example, quartz or ceramics. The inner tube 10a is at least partially located between the first electrode 110 and the second electrode 120 and provides insulation protection. Therefore, the inner tube 10a may alternatively be an insulating partition member 10b. The outer tube 20 is sleeved outside the second electrode 120 and the inner tube 10a.

In an aspect, referring to FIG. 18, there is no blocking by another object in an interval between the first electrode 110 and the second electrode 120 that are opposite.

The interval between the first electrode 110 and the second electrode 120 that are opposite and spaced apart is a discharge region 130. The plasma is generated in the discharge region 130, so that the temperature of the center of the discharge region 130 is higher than the temperature of other parts of the heating assembly 100. A voltage of a specific magnitude and frequency is applied, an electrical breakdown occurs between the first electrode 110 and the second electrode 120, and the plasma is generated through discharge by an arc. The discharging arc may be generated with a hiss. In this embodiment, the first electrode 110 and the second electrode 120 may be connected to a direct current, or may be connected to an alternating current. When the direct current is applied to the first electrode 110 and the second electrode 120, the first electrode 110 and the second electrode 120 use the direct current to form the plasma. When the alternating current is applied to the first electrode 110 and the second electrode 120, the first electrode 110 and the second electrode 120 use the alternating current to form the plasma. A voltage of a specific magnitude and frequency is applied, the first electrode 110 and the second electrode 120 may alternatively generate the plasma through a glow discharge. A glow discharge process may be accompanied by glow of a specific color.

In an aspect, referring to FIG. 2, in the interval between the first electrode 110 and the second electrode 120 that are opposite, a gap 1300 is formed between at least a part of the insulating partition member 10b forms a gap 1300 and the first electrode 110 and/or the second electrode 120, and the plasma is generated in the gap 1300. In this embodiment, the first electrode 110 and the second electrode 120 generate the plasma through a dielectric barrier discharge. In this embodiment, a high-voltage alternating current is applied to the first electrode 110 and the second electrode 120.

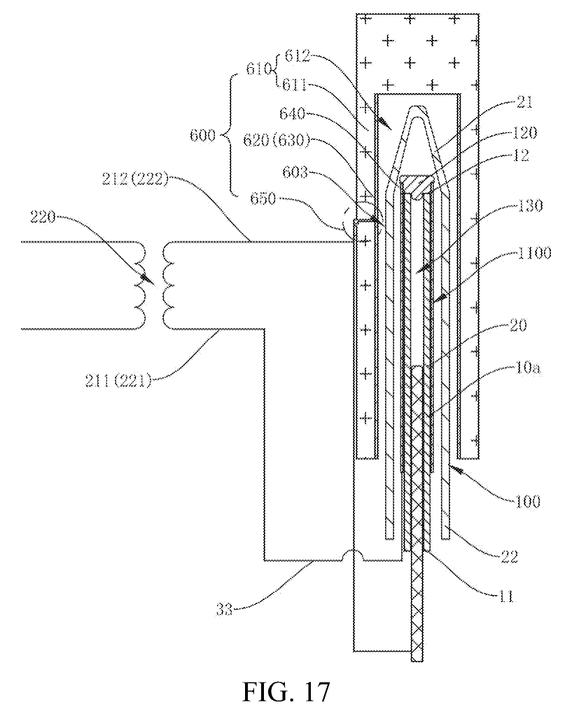

Referring to FIG. 1 and FIG. 17, in an aspect, the cleaning assembly 600 includes a third electrode 630 and a fourth electrode 640, and the third electrode 630 is the foregoing electrode 620. The third electrode 630 is disposed between the hollow member 610 and the outer tube 20, and the fourth electrode 640 is at least partially disposed in the outer tube 20. When the third electrode 630 and the fourth electrode 640 are energized, the plasma is generated in the cleaning gap 603.

In this way, the outer tube 20 at least partially blocks between the third electrode 630 and the fourth electrode 640, and the third electrode 630 and the fourth electrode 640 generate the plasma in the cleaning gap 603 through a dielectric barrier discharge, so that the cleaning assembly 600 can clean the outer tube 20 by using the plasma.

Specifically, the third electrode 630 may be disposed between the hollow member 610 and the outer tube 20. The side of the third electrode 630 faces the hollow member 610, and the opposite side faces the outer wall 2001 of the outer tube 20. The cleaning gap 603 is formed between the side of the third electrode 630 facing the outer tube 20 and the outer wall 2001 of the outer tube 20.

The part of the hollow member 610 may surround the central axis of the outer tube 20 to form a side enclosure 611 and a hollow interval 612. The third electrode 630 may be fixedly disposed on the side enclosure 611. The side of the third electrode 630 facing the hollow member 610 may be adhered to the hollow member 610, or may be spaced apart from the hollow member 610 by a specific distance. The third electrode 630 may be a tube, a plate, or the like, or may be a conductive film or a conductive wire coated on the inner surface of the hollow member 610.

The fourth electrode 640 may be tube-shaped, is sleeved outside the inner tube 10a, and extends into the outer tube 20. The end of the fourth electrode 640 extending into the outer tube 20 may be disposed to partially abut against the tapered end portion 21, and extend from the tapered end portion 21 to the exposed end 22 in the axial direction of the outer tube 20.

In this embodiment, the fourth electrode 640 and the second electrode 120 may be two electrodes disposed in the outer tube 20.

The fourth electrode 640 and the third electrode 630 are at least partially opposite to each other. For example, the part of the fourth electrode 640 extending in the axial direction of the outer tube 20 is opposite to the part of the third electrode 630 adhered to the side enclosure 611. The third electrode 630 and the fourth electrode 640 may be respectively connected to two poles of the power source 200, so that the plasma is generated by discharging between the third electrode 630 and the fourth electrode 640.

In an aspect, the fourth electrode 640 may be kept at a specific distance from the wall of the outer tube 20, so that a thermal insulation gap 1002 is formed between the fourth electrode 640 and the inner wall of the outer tube 20. The third electrode 630 may be adhered to the inner surface of the hollow member 610. The cleaning gap 603, the outer tube 20, and the thermal insulation gap 1002 are sequentially disposed between the third electrode 630 and the fourth electrode 640. The thermal insulation gap 1002 can reduce a risk of overheat of the outer tube 20 in the heating assembly 100.

In an aspect, the fourth electrode 640 may be adhered to the inner surface of the outer tube 20, opposite to the third electrode 630, and separated from the third electrode 630 by the wall of the outer tube 20 and the cleaning gap 603.

The end of the fourth electrode 640 abutting against the tapered end portion 21 may be closed. The shape of the fourth electrode 640 may match the shape of the inner wall of the outer tube 20. The end of the fourth electrode 640 abutting against the tapered end portion 21 may protrude toward the inner wall of the outer tube 20 and match the shape of the end portion of the outer tube 20. The third electrode 630 may be partially disposed on the hollow member 610 at the position opposite to the tapered end portion 21, so that a residual at the top of the outer tube 20 can be cleaned by the plasma formed between the third electrode 630 and the fourth electrode 640.

It may be understood that, at least one of the third electrode 630 and the fourth electrode 640 is blocked and covered by the outer tube 20. The third electrode 630 and the fourth electrode 640 generate the plasma through a dielectric barrier discharge. As described above, the third electrode 630 and the fourth electrode 640 are configured to be subjected to a high-voltage alternating current. A process of the dielectric barrier discharge to form the plasma may be understood as that when electrons between the two electrodes are accelerated by a strong electric field and gain enough energy to overcome an energy barrier in the dielectric, resulting in electron penetration, the plasma is formed.

In an aspect, air in the cleaning gap 603 may be used as the working gas for being ionized to form the plasma. Alternatively, the cleaning gap 603 may be filled with nitrogen, argon, carbon dioxide, or the like as the working gas.

In an aspect, the fourth electrode 640 and the second electrode 120 are configured as the same electrode.

In this way, the fourth electrode 640 and the second electrode 120 are the same electrode, so that the internal structure of the heating assembly 100 is more simplified, a circuit routing arrangement of the aerosol generating device 1000 is relatively simplified, and in addition, costs can be reduced.

Specifically, the second electrode 120 and the fourth electrode 640 may both be opposite to the other electrode and are subjected to a high voltage, to generate the plasma through charging. The second electrode 120 and the fourth electrode 640 may both be discharge elements disposed in the outer tube 20. The second electrode 120 generates the plasma to heat the aerosol generating substrate 300 to generate the aerosol, and the fourth electrode 640 generates the plasma to clean the residual generated from generation of the aerosol, and is not used at a use stage. Therefore, an electrode may be disposed in the outer tube 20. The electrode is opposite to the first electrode 110 inside the outer tube 20, and is also opposite to the third electrode 630 outside the outer tube 20. When the electrode and the first electrode 110 are energized, the electrode serves as the second electrode 120, and when the electrode and the third electrode 630 are energized, the electrode serves as the fourth electrode 640.

In an aspect, when the first electrode 110 and the second electrode 120 are energized, the third electrode 630 and the fourth electrode 640 are de-energized; and when the third electrode 630 and the fourth electrode 640 are energized, the first electrode 110 and the second electrode 120 are de-energized.

In this way, working stages of the cleaning assembly 600 and the heating assembly 100 can be staggered, thereby reducing a possibility that a cleaning process of the cleaning assembly 600 causes an adverse effect on a heating process of the heating assembly 100.

Specifically, the first electrode 110, the second electrode 120 (the fourth electrode 640), and the third electrode 630 may be connected to the same power source 200. As described above, it may be understood that, when the first electrode 110 and the second electrode 120 are energized, the first electrode 110 and the second electrode 120 discharge inside the outer tube 20 to generate the plasma, and a large amount of heat is released, and the aerosol generating substrate 300 absorbs the heat outside the outer tube 20 to generate the aerosol. When the third electrode 630 and the fourth electrode 640 are energized, the third electrode 630 and the fourth electrode 640 discharge outside the outer tube 20 to generate the plasma, to burn the residual generated from the generation of the aerosol.

When the first electrode 110 and the second electrode 120 are energized, the cleaning assembly 600 may be kept at a relatively long distance from the heating assembly 100, and the heating assembly 100 is not inserted into the hollow member 610.

When the third electrode 630 and the fourth electrode 640 are energized, the heating assembly 100 is inserted into the cleaning assembly 600, and the outer tube 20 is at least partially opposite to the third electrode 630.

Referring to FIG. 1 and FIG. 3, in an aspect, the aerosol generating device 1000 includes the power source 200, the second electrode 120 is electrically connected to a first power supply terminal 211 of the power source 200, when the hollow member 610 is sleeved outside the outer tube 20, the third electrode 630 is electrically connected to a second power supply terminal 212 of the power source 200, and when the hollow member 610 is separated from the outer tube 20, the first electrode 110 is electrically connected to the second power supply terminal 212 of the power source 200.

In this way, the same group of power sources 200 may differently supply power to one group of electrodes in the first electrode 110 and the second electrode 120 or the third electrode 630 and the second electrode 120 (the fourth electrode 640) based on a use state of the cleaning assembly 600, so that the first electrode 110 and the second electrode 120 are energized and the third electrode 630 and the fourth electrode 640 are de-energized in a state in which the aerosol generating device 1000 generates the aerosol; and the third electrode 630 and the fourth electrode 640 are energized and the first electrode 110 and the second electrode 120 are de-energized in a cleaning state.

Specifically, the power source 200 may include a battery 210, and the battery 210 may be a battery cell or a battery pack. The first power supply terminal 211 and the second power supply terminal 212 may respectively form two ends at different potentials. The second electrode 120 and the first power supply terminal 211, the third electrode 630 and the second power supply terminal 212, and the first electrode 110 and the second power supply terminal 212 may all be connected by leads, and a circuit is conducted.

When the hollow member 610 is sleeved outside the outer tube 20, the aerosol generating device 1000 is in the cleaning state, and the cleaning assembly 600 uses the plasma to clean the heating assembly 100. The second electrode 120, namely, the fourth electrode 640, and the third electrode 630 are respectively connected to the first power supply terminal 211 and the second power supply terminal 212 at different potentials. A potential difference is formed between the fourth electrode 640 and the third electrode 630, thereby forming the plasma in the cleaning gap 603 by using the effect of the electric field. In this case, the first electrode 110 and the second electrode 120 are de-energized, and the heating assembly 100 hardly forms the plasma. When the hollow member 610 is separated from the outer tube 20, the aerosol generating device 1000 is in an aerosol generating state. The second electrode 120 and the first electrode 110 are respectively connected to the first power supply terminal 211 and the second power supply terminal 212 that are at different electric potentials. A potential difference is formed between the second electrode 120 and the first electrode 110, thereby generating the plasma by using the effect of the electric field in the heat generation mechanism 1100, to heat the aerosol generating substrate 300 to form the aerosol. In this case, the third electrode 630 and the fourth electrode 640 are de-energized, and the plasma is hardly formed in the cleaning assembly 600.

In an aspect, the aerosol generating device 1000 further includes a control center 400. The control center 400 is connected to the heating assembly 100 and the power source 200, and can adjust output power of the power source 200, to control the heating temperature of the heating assembly 100.

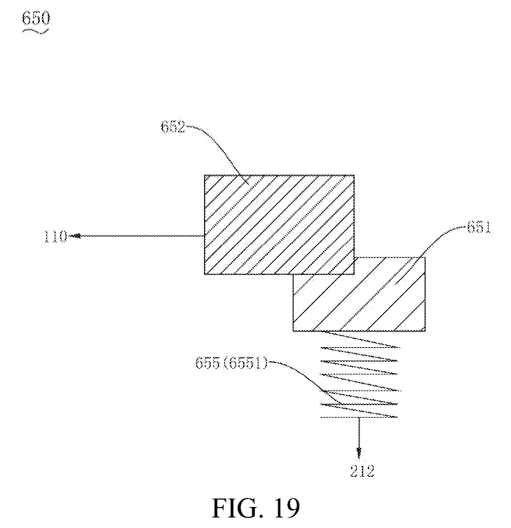

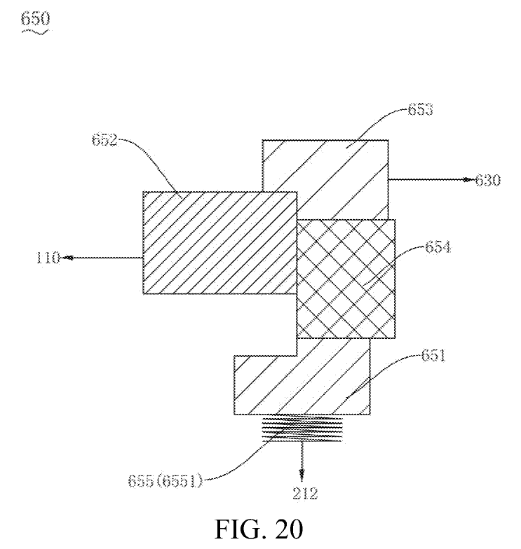

Referring to FIG. 1, FIG. 19, and FIG. 20, in an aspect, the aerosol generating device 1000 includes a power connection assembly 650, the power connection assembly 650 includes a first connector 651, a second connector 652, and a third connector 653, the first connector 651 is connected to the first electrode 110, the second connector 652 is electrically connected to the second power supply terminal 212, and the third connector 653 is disposed on the hollow member 610 and is electrically connected to the third electrode 630; and when the hollow member 610 is sleeved outside the outer tube 20, the second connector 652 is in contact with the third connector 653, and when the hollow member 610 is separated from the outer tube 20, the second connector 652 is in contact with the first connector 651.

In this way, the power connection assembly 650 can be used to control the second electrode 120 and one of the first electrode 110 or the third electrode 630 to be energized, thereby controlling the aerosol generating device 1000 to be in the aerosol generating state or the cleaning state.

Specifically, the power connection assembly 650 is at least partially embedded into the hollow member 610. The first connector 651, the second connector 652, and the third connector 653 may all be embedded into the hollow member 610, or only the third connector 653 may be embedded into the hollow member 610. The power connection assembly 650 may alternatively be partially exposed on the surface of the hollow member 610.

When the hollow member 610 is sleeved outside the outer tube 20, referring to FIG. 20 and with reference to FIG. 1, the second connector 652 is in contact with the third connector 653, the second connector 652 is electrically connected to the second power supply terminal 212, and the third electrode 630 is electrically connected to the third electrode 630, so that the third electrode 630 is electrically connected to the second power supply terminal 212. The fourth electrode 640 remains electrically connected to the first power supply terminal 211. Therefore, when the hollow member 610 is sleeved outside the outer tube 20, the third electrode 630 and the fourth electrode 640 are energized, the first electrode 110 and the second electrode 120 (the fourth electrode 640) are de-energized, and the third electrode 630 and the fourth electrode 640 discharge in the cleaning gap 603 to generate the plasma to clean the outer wall 2001 of the outer tube 20. In this case, the aerosol generating device 1000 is in the cleaning state.

When the hollow member 610 is separated from the outer tube 20, referring to FIG. 19 and with reference to FIG. 1, the second connector 652 is in contact with the first connector 651, the second connector 652 is electrically connected to the second power supply terminal 212, and the first connector 651 is electrically connected to the first electrode 110, so that the first electrode 110 is electrically connected to the second power supply terminal 212. The second electrode 120 remains electrically connected to the first power supply terminal 211. Therefore, when the hollow member 610 is separated from the outer tube 20, the first electrode 110 and the second electrode 120 are energized, the third electrode 630 and the fourth electrode 640 (the second electrode 120) are de-energized, the first electrode 110 and the second electrode 120 are spaced apart in the inner tube 10a and generate the plasma, thereby releasing heat to cause the aerosol generating substrate 300 to be atomized to form the aerosol. In this case, the aerosol generating device 1000 is in the aerosol generating state.

Referring to FIG. 1, FIG. 19, and FIG. 20 again, in an aspect, the power connection assembly 650 includes an insulating member 654 and an elastic member 655, the insulating member 654 is connected to the third connector 653, the elastic member 655 is connected to the first connector 651, in a process of sleeving the hollow member 610 on the outer tube 20, the insulating member 654 pushes the first connector 651 to move relative to the second connector 652, to separate the first connector 651 from the second connector 652 and deform the elastic member 655, and in a process of separating the hollow member 610 from the outer tube 20, the elastic member 655 recovers from deformation, to push the first connector 651 to come into contact with the second connector 652.

In this way, by using a simple mechanical structure, power-on and power-off of the two groups of electrodes can be controlled, which has low costs and strong practicability. Specifically, the insulating member 654 includes, but is not limited to, a quartz block, a ceramics block, a rubber block, and the like. The elastic member 655 may be a spring 6551, an elastic string, elastic rubber, or the like. Using an example in which the elastic member 655 is the spring 6551, one end of the spring 6551 may be fixed to one side surface of the first connector 651, and one end is fixed to the cleaning assembly. The first connector 651, the second connector 652, and the third connector 653 may all be made of a metal material having good electrical conductivity.

In an embodiment, the hollow member 610 is gradually separated from the outer tube 20, and the spring 6551 gradually extends, to push out the first connector 651, so that the first connector 651 is gradually close to the second connector 652. When the hollow member 610 is completely separated from the outer tube 20, as shown in FIG. 19, an elastic support force provided by extension of the spring 6551 is sufficient to support the first connector 651 in surface contact with the second connector 652, thereby forming an electrical connection, so that the first electrode 110 is electrically connected to the second power supply terminal 212, and the first electrode 110 and the second electrode 120 are energized.

Correspondingly, in a process in which the hollow member 610 is sleeved on the outer tube 20, the insulating member 654 is located between the first connector 651 and the third connector 653, the second connector 652 is pushed to compress the spring 6551, the spring 6551 is compressed and shortened, the second connector 652 is gradually separated from the second connector 652, and the third connector 653 gradually moves with the insulating member 654, to abut against the second connector 652. When the hollow member 610 is completely sleeved outside the outer tube 20 at a predetermined position, as shown in FIG. 20, the third connector 653 remains in contact with the second connector 652, and the first connector 651 is completely separated from the second connector 652, so that the second power supply terminal connected to the second connector 652 forms electrical connection with the third electrode 630 connected to the third connector 653, the first electrode 110 and the second electrode 120 are de-energized, and the third electrode 630 and the fourth electrode 640 (the second electrode 120) are energized.

It needs to be noted that pushing out the first connector 651 by using the insulating member 654 is merely an example of controlling the electrode to be energized according to the aerosol generating device 1000 in this disclosure, electrical connection and controlling manners are not limited to the foregoing example, and further include magnetic attraction and the like, for example, controlling conduction and disconnection of a circle through magnetic attraction.

Referring to FIG. 1 and FIG. 3 again, in an aspect, the power source 200 includes a transformer 220, a first secondary side 221 of the transformer 220 forms the first power supply terminal 211, and a second secondary side 222 of the transformer 220 forms the second power supply terminal 212.

In this way, the power source 200 may provide a high-voltage alternating current to the first electrode 110 and the second electrode 120, and the third electrode 630 and the fourth electrode 640 by using the battery 210 that has small power and a small size.

In the transformer 220, a power source side is a primary side, and a side without a power source, or a high-voltage side of a boost transformer and a low-voltage side of a buck transformer are secondary sides.

A number of coil turns of a line corresponding to a different secondary side is different, and a terminal voltage thereof is also different. Therefore, the transformer 220 may provide a corresponding voltage for an unused line.

Specifically, the transformer 220 in this example of this disclosure may be a boost transformer, and a high-voltage alternating current is applied between the first electrode 110 and the second electrode 120, and between the third electrode 630 and the fourth electrode 640. It may be understood that a glow discharge or a dielectric barrier discharge usually needs a voltage on the order of 10³to 10⁴to generate the plasma. Due to a requirement for miniaturization of the aerosol generating device 1000, the output voltage of the battery 210 that the power source 200 can match is limited. Therefore, the boost transformer may be used to apply high-voltage electricity to the electrode.

With reference to the foregoing descriptions, the second electrode 120 (the fourth electrode 640) is electrically connected to the first secondary side 221 of the transformer 220. When the hollow member 610 is sleeved outside the outer tube 20, the third electrode 630 is electrically connected to the second secondary side 222 of the transformer 220. A high-voltage alternating current is applied to the third electrode 630 and the fourth electrode 640, so that an alternating electric field having a relatively high electrical field strength may be formed in the cleaning gap 603. When the hollow member 610 is separated from the outer tube 20, the first electrode 110 is electrically connected to the second secondary side 222 of the transformer 220, and an alternating electric field having a relatively high electric field strength is formed between the first electrode 110 and the second electrode 120.

Referring to FIG. 1 and FIG. 17, in an aspect, the third electrode 630 is a tube and is disposed on the inner wall of the hollow member 610.

In this way, the third electrode 630 is a tube and is disposed on the inner wall of the hollow member 610, so that it is convenient to mount the third electrode 630 and limit the position of the third electrode 630.

Specifically, the hollow interval 612 of the hollow member 610 may be formed by the hollow member 610 encircling the central axis of the outer tube 20. In addition, the hollow member 610 has two ends in the axial direction of the outer tube 20, one end is closed, and one end is open. The side enclosure 611 of the hollow member 610 may be the part that encircles the outer tube 20 and extends in the axial direction of the outer tube 20. The heating assembly 100 may partially extend into the hollow interval 612 from an opening of the hollow member 610, and is partially exposed outside the hollow member 610 from the opening of the hollow member 610.

For example, the third electrode 630 may be a hollow tube, has a thin tube wall, and is adhered to the surface of the inner wall of the hollow member 610. The third electrode 630 may be sleeved outside the outer tube 20, and is coaxial with the outer tube 20. The inner diameter of the third electrode 630 is greater than the outer diameter of the outer tube 20. It needs to be noted that the cross-sectional shapes of the third electrode 630 and the outer tube 20 include, but are not limited to, a circle, an ellipse, a square, a polygon, and the like. The inner diameter of the third electrode 630 may be the diameter of the inscribed circle of the cross-sectional shape of the third electrode 630, and the outer diameter of the outer tube 20 may be the diameter of the circumscribed circle of the cross-section of the outer tube 20.

The direction from a closed end of the hollow member 610 to an open end of the hollow member 610 may be an up-to-down direction. The axial direction of the third electrode 630 may be approximately parallel to the up-down direction. The upper end of the third electrode 630 may abut against the deepest portion of the hollow interval 612 in the axial direction of the third electrode 630.

In an aspect, two ends of the third electrode 630 in the axial direction of the third electrode 630 may each have an opening, and the third electrode 630 is adhered to the side enclosure 611 and is opposite to a portion of the fourth electrode 640 extending in the axial direction of the outer tube 20. In the radial direction of the outer tube 20, the third electrode 630 and the fourth electrode 640 may be shaped as a parallel-plate electrode pair. The cleaning gap 603 is provided in an interval in which the third electrode 630 and the fourth electrode 640 are opposite, and the plasma is formed in the cleaning gap 603.

In an aspect, the upper end of the third electrode 630 may be closed, and is adhered to the inner wall surface of the tapered end portion 21 of the hollow member 610 opposite to the outer tube 20. The closed upper end portion (not shown in the figure) of the third electrode 630 may be opposite to the tapered end portion 21 of the outer tube 20 that is spaced apart from the fourth electrode 640. The cleaning gap 603 also includes a gap formed between the outer wall 2001 of the tapered end portion 21 and the upper end portion of the third electrode 630.

The third electrode 630 may be made of a metal material or an alloy material having good electrical connectivity. For example, the third electrode 630 may be made of at least one of materials such as copper alloy, nickel and nickel-based alloy, stainless steel, zirconium, hafnium, and tungsten.

Referring to FIG. 18, in an aspect, the heating assembly 100 includes an inner tube 10a, the inner tube 10a is at least partially inserted into the outer tube 20, the first electrode 110 is at least partially inserted into the inner tube 10a, and the second electrode 120 is at least partially disposed at one end of the inner tube 10a. In this way, the first electrode 110 and the second electrode 120 are opposite in the inner tube 10a, and generate a plasma arc in the inner tube 10a. An arc discharge may improve the efficiency of heating the aerosol generating substrate 300.

Specifically, in this example, the inner tube 10a is a through-tube and has an opening at both ends in the axial direction of the inner tube 10a, and the opening runs through the inner tube 10a in the axial direction. The inner tube 10a extends into the outer tube 20, and one end is close to the tapered end portion 21. The second electrode 120 may be a tube and has one end closed, and the end portion is disposed on the inner tube 10a close to the tapered end portion 21. The first electrode 110 extends into the inner tube 10a, and the second electrode 120 may be sleeved outside the inner tube 10a. Therefore, the first electrode 110, the inner tube 10a, the second electrode 120, and the outer tube 20 are sequentially sleeved, to form the heating assembly 100. In an aspect, the first electrode 110, the inner tube 10a, the second electrode 120, and the outer tube 20 may be approximately coaxial. The parts of the first electrode 110 and the second electrode 120 that are located at the end portion of the inner tube 10a are spaced apart by a predetermined distance in the inner tube 10a. An interval between the first electrode 110 and the second electrode 120 in the inner tube 10a is the discharge region 130, and the plasma is generated in the discharge region 130. A distance range between the first electrode 110 and the second electrode 120, that is, the axial length of the discharge region 130, may range from 4 mm to 10 mm. For example, the axial length of the discharge region 130 may range from 4 mm to 10 mm, from 5 mm to 8 mm, from 6 mm to 7 mm, from 5.5 mm to 6 mm, or the like. For another example, the axial length of the discharge region 130 may be 4.1 mm, 5 mm, 6 mm, 7 mm, 8 mm, 9 mm, 10 mm, or other lengths.

Still referring to FIG. 18, in an aspect, the inner tube 10a includes a first end surface 11 and a second end surface 12 opposite to the first end surface 11, the first electrode 110 exposes the inner tube 10a on the first end surface 11, and the second electrode 120 abuts against the second end surface 12.

In this way, assembly of the heat generation mechanism 1100 is relatively clear and convenient, thereby facilitating production of the heating assembly 100.

Specifically, the first end surface 11 and the second end surface 12 may be end surfaces of two ends of the inner tube 10a in the axial direction. The inner tube 10a extends into the outer tube 20, one end having the second end surface 12 may be close to the tapered end portion 21, and one end having the first end surface 11 may be partially exposed out of the outer tube 20 from the exposed end 22. The inner tube 10a is a through-tube, and a through-hole of the inner tube 10a may run through the center of the first end surface 11 and the second end surface 12.

The part of the second electrode 120 abutting against the second end surface 12 may be disk-shaped and be adhered to the second end surface 12. The second electrode 120 may partially protrude into the inner tube 10a from the center of the second end surface 12, to form a protrusion 122. The first electrode 110 may be inserted into the inner tube 10a from a central opening of the first end surface 11. One end of the first electrode 110 inserted into the inner tube 10a faces the second electrode 120, and is spaced apart from the first end surface 11 by a predetermined distance. It may be understood that, in this embodiment, the distance between the end of the first electrode 110 facing the second electrode 120 and the first end surface 11 is approximately the same as the distance between the first electrode 110 and the second electrode 120. The end portion of the first electrode 110 facing the second electrode 120 may alternatively be an arc surface slightly protruding, and is opposite to the protrusion 122, and the principle of a tip discharge is used to facilitate formation of the plasma arc.

A lead connecting the second electrode 120 and the first power supply terminal 211 may exit between the first end surface 11 and the second end surface 12, to stagger the exit of a lead connecting the first electrode 110 and the second power supply terminal 212. As described above, the inner tube 10a may provide insulation protection between a lead connecting the first power supply terminal 211 and the second power supply terminal 212.

In an aspect, the insulating partition member 10b may alternatively be a plate, and is adhered to at least one of the first electrode 110 and the second electrode 120.

In an aspect, the electrode 620 is the third electrode 630, and when the first electrode 110 and the second electrode 120 are energized, the third electrode 630 and the second electrode 120 are de-energized; and when the third electrode 630 and the second electrode 120 are energized, the first electrode 110 and the second electrode 120 are de-energized.

In this way, when the heating assembly 100 generates the plasma to heat the aerosol generating substrate 300, the cleaning assembly 600 is de-energized; and when the cleaning assembly 600 generates the plasma to clean the outer tube 20, the heating assembly 100 is de-energized, so that processes of aerosol generation and cleaning by the aerosol generating device 1000 do not interfere with each other.

When the first electrode 110 and the second electrode 120 are energized, the cleaning assembly 600 may be kept at a relatively long distance from the heating assembly 100, the heating assembly 100 is not inserted into the hollow member 610, and the third electrode 630 and the second electrode 120 are de-energized. When the first electrode 110 and the second electrode 120 are energized, the first electrode 110 and the second electrode 120 discharge inside the outer tube 20 to generate the plasma, and a large amount of heat is released, and the aerosol generating substrate 300 absorbs the heat outside the outer tube 20 to generate the aerosol.

The heating assembly 100 is inserted into the cleaning assembly 600, the outer tube 20 is at least partially opposite to the third electrode 630, to form the cleaning gap 603, and the third electrode 630 and the second electrode 120 are energized. When the third electrode 630 and the second electrode 120 are energized, the third electrode 630 and the second electrode 120 discharge in the cleaning gap 603 between the third electrode 630 and the outer wall 2001 to generate the plasma, to burn the residual generated from the generation of the aerosol.

As described above, the power connection assembly 650 may be used to control the second electrode 120, and one of the first electrode 110 and the third electrode 630 to be energized, thereby controlling one of the cleaning assembly and the heating assembly to generate the plasma. In an embodiment, the second connector 652 is in contact with the first connector 651, and the second electrode 120 and the first electrode 110 are controlled to be energized. In this case, the second electrode 120 and the third electrode 630 are de-energized. The second connector 652 is in contact with the third connector 653, and the second electrode 120 and the third electrode 630 are controlled to be energized. In this case, the first electrode 110 and the second electrode 120 are energized.

In an aspect, referring to FIG. 16, the heating assembly 100 further includes a base 90, configured to mount and fix the heating assembly 100. Referring to FIG. 1 and FIG. 17, in an aspect, the width of the cleaning gap 603 is 0.1 mm to 1 mm (including endpoint values). In this way, the width of the cleaning gap 603 between the third electrode 630 and the outer wall 2001 of the outer tube 20 is properly set, so that the generation efficiency of the plasma in the gap can be improved, thereby improving the cleaning effect.

Specifically, the shortest distance between the side of the third electrode 630 facing the outer tube 20 and the outer wall 2001 of the outer tube 20 in the radial direction of the outer tube 20 may be considered as the width of the cleaning gap 603. The widths of the cleaning gap 603 at different positions may not be equal. In an aspect, the third electrode 630 is a circular tube sleeved outside the outer tube 20, and is coaxial with the outer tube 20. The outer tube 20 is cylindrical. In this embodiment, the width of the cleaning gap 603 in the circumferential direction of the outer tube 20 is approximately equal.

For example, the width of the cleaning gap 603 may be 0.1 mm to 1 mm, 0.2 mm to 0.9 mm, 0.3 mm to 0.8 mm, 0.4 mm to 0.7 mm, 0.5 mm to 0.6 mm, or the like. For another example, the width of the cleaning gap 603 may be 0.1 mm, 0.11 mm, 0.2 mm, 0.25 mm, 0.4 mm, 0.65 mm, 0.8 mm, 0.9 mm, 1 mm, or the like.

In conclusion, referring to FIG. 1 and FIG. 17 again, the cleaning assembly 600 in this example of this disclosure includes the hollow member 610 and the electrode 620.

The hollow member 610 is configured to be detachably sleeved outside the outer tube 20 of the aerosol generating device 1000. The electrode 620 is disposed in the hollow member 610 and configured to form the gap with the outer wall 2001 of the outer tube 20, and the electrode 620 is configured to generate the plasma in the gap. The gap formed by the electrode 620 and the outer wall 2001 is the cleaning gap 603.

The cleaning assembly 600 has at least two electrodes 620, where one electrode is disposed on the hollow member 610, and the other electrode may be disposed on the outer tube 20. At least the outer tube 20 and the cleaning gap 603 are disposed between the two electrode 620. A voltage at a specific strength is applied to the two electrodes 620, and the two electrodes 620 may generate the plasma in the cleaning gap 603 through the dielectric barrier discharge. The cleaning assembly 600 may process and decompose the residual into small molecules, for example, a volatile organic substance, light oxide, and water vapors, by using the plasma. A decomposition product of a small molecule may be volatilized in a form of a gas.

In this way, the cleaning assembly 600 can clean the aerosol residual on the outer wall 2001 of the outer tube 20, thereby improving the efficiency of heating the aerosol generating substrate 300 when the heating assembly 100 is used again, and facilitating generation of the aerosol. In addition, the cleaning assembly 600 cleans the outer tube 20 by using the plasma, damage to elements is not easily caused, the elements are easy to be cleaned, and the cleaning temperature is relatively easy to be controlled, and has little impact on reliability of the heating assembly 100.

In the descriptions of the specification, features, structures, materials, or characteristics described with reference to the examples are included in at least one implementation or example of this disclosure. In the specification, exemplary descriptions of the foregoing terms do not necessarily refer to the same. In addition, the described specific features, structures, materials, or characteristics may be combined in a proper manner in any one or more of implementations or examples.

Although the examples of this disclosure have been shown and described, a person of ordinary skill in the art may understand that various changes, modifications, replacements, and variations may be made to these examples without departing from the principle and spirit of this disclosure. The scope of this disclosure is limited by the claims and their equivalent.

What is claimed is:

1. A heating assembly comprising:
an outer tube being configured for contact with an aerosol generating substrate;
a first electrode and a second electrode being spaced apart and both at least partially disposed in the outer tube;
an insulating partition member being disposed between the first electrode and the second electrode;
a gap being formed between a part of the insulating partition member and at least one of the first electrode and the second electrode; and
a plasma being generated in the gap when the first electrode and the second electrode are energized.

2. The heating assembly of claim 1, wherein the first electrode is at least partially inserted into the insulating partition member, and the second electrode is located outside the insulating partition member.

3. The heating assembly of claim 2, wherein the insulating partition member comprises a closed end and an open end opposite to the closed end, the closed end is located in the outer tube, and the first electrode is inserted into the insulating partition member from the open end.

4. The heating assembly of claim 2, wherein the second electrode is sleeved outside the insulating partition member, and an upper end surface of at least one of the first electrode and the second electrode is lower than an upper end surface of the insulating partition member.

5. The heating assembly of claim 4, wherein a hollowed-out portion is formed on the second electrode, the insulating partition member is partially face the outer tube through the hollowed-out portion.

6. The heating assembly of claim 2, wherein a thickness of the insulating partition member ranges from 0.2 mm to 1 mm.

7. The heating assembly of claim 1, wherein
the second electrode is adhered to the insulating partition member, or
the second electrode is adhered to a inner wall of the outer tube.

8. The heating assembly of claim 1, the insulating partition member further comprising:
a first insulating partition member wrapping the first electrode,
a second insulating partition member wrapping the second electrode, and
the first electrode and the second electrode are disposed in parallel.

9. The heating assembly of claim 1, further comprising:
a sealing member being connected to a inner wall of the outer tube and a first enclosed space being formed with the outer tube,
the first enclosed space being filled with a working gas, and
the first electrode and/or the second electrode is at least partially located in the first enclosed space.

10. The heating assembly of claim 9, further comprising:
a base,
a second enclosed space being formed in the base, and
a part of the first electrode located outside the first enclosed space and/or an end of the outer tube having an opening is located in the second enclosed space.

11. An aerosol generating device comprising:
a heating assembly including an outer tube and a heat generation mechanism disposed in the outer tube; and
a cleaning assembly including a hollow member and an electrode, the hollow member being detachably sleeved outside the outer tube, the electrode being disposed between the hollow member and the outer tube, and a gap being formed with the outer wall of the outer tube, and the electrode being configured to generate plasma in the gap.

12. The aerosol generating device of claim 11, the heat generation mechanism further comprising:
a first electrode and a second electrode,
the first electrode and the second electrode being both at least partially disposed in the outer tube, the first electrode and the second electrode being spaced apart, and
a plasma being generated between the first electrode and the second electrode when the first electrode and the second electrode are energized.

13. The aerosol generating device of claim 12, the cleaning assembly further comprising:
a fourth electrode being at least partially disposed in the outer tube, and the plasma being generated in the gap when the electrode and the fourth electrode are energized.

14. The aerosol generating device of claim 13, wherein the fourth electrode and the second electrode are configured as one electrode.

15. The aerosol generating device of claim 13, wherein
when the first electrode and the second electrode are energized, the electrode and the fourth electrode are de-energized; and
when the electrode and the fourth electrode are energized, the first electrode and the second electrode are de-energized.

16. The aerosol generating device of claim 15, the aerosol generating device further comprising:
a power source,
the second electrode being electrically connected to a first power supply terminal of the power source,
when the hollow member is sleeved outside the outer tube, the electrode is electrically connected to a second power supply terminal of the power source, and
when the hollow member is separated from the outer tube, the first electrode is electrically connected to the second power supply terminal of the power source.

17. The aerosol generating device of claim 13, wherein the electrode is a tube and is disposed on the inner wall of the hollow member.

18. The aerosol generating device of claim 12, the heating assembly further comprising:
an inner tube being at least partially disposed in the outer tube,
the first electrode being at least partially disposed in the inner tube, and
the second electrode is at least partially disposed at one end of the inner tube.

19. The aerosol generating device of claim 18, wherein
the inner tube comprises a first end surface and a second end surface opposite to the first end surface,
the first electrode exposes the inner tube on the first end surface, and
the second electrode abuts against the second end surface.

20. The aerosol generating device of claim 19, wherein
when the first electrode and the second electrode are energized, the electrode and the fourth electrode are de-energized; and
when the electrode and the fourth electrode are energized, the first electrode and the second electrode are de-energized.
